(19) United States
(12) Patent Application Publication
(10) Pub. No.: US 2009/0023127 A1
(43) Pub. Date: Jan. 22, 2009

(54) TISSUE SYSTEM AND METHODS OF USE

(75) Inventors: Hanry YU, Singapore (SG); Yuet Mei Khong, Singapore (SG); Feng Wen, Singapore (SG)

Correspondence Address: INTELLECTUAL PROPERTY / TECHNOLOGY LAW, PO BOX 14329, RESEARCH TRIANGLE PARK, NC, 27709, US

(73) Assignee: Agency for Science, Technology and Research, Singapore (SG)

(21) Appl. No.: 12/185,746

(22) Filed: Aug. 4, 2008

Related U.S. Application Data
(63) Continuation-in-part of application No. 11/577,091.
(60) Provisional application No. 60/618,030, filed on Oct. 12, 2004.

(51) Int. Cl. A01N 1/02

(52) U.S. Cl. 435/1.2; 435/284.1

(57) ABSTRACT

Apparatus and methods of use of a tissue system for culture and perfusion. The apparatus comprises a needle for injecting a fluid into the tissue.

### CROSS-REFERENCE TO RELATED APPLICATIONS

This application is a continuation-in-part of U.S. patent application Ser. No. 11/577,091, which claims the priority benefit of the filing date of International Patent Application PCT/SG2005/000346, filed Oct. 7, 2005, which in turn claims the benefit of U.S. provisional patent application 60/618,030 filed Oct. 12, 2004. The disclosures of said U.S. patent application, said International patent application and said U.S. provisional patent application are incorporated herein by reference in their respective entireties.

### FIELD OF THE INVENTION

This invention relates generally to a tissue system.

### BACKGROUND OF THE INVENTION

Maintaining adequate mass transfer in an engineered tissue construct is critical. The molecular diffusion of nutrients and oxygen is no more than a 100-200 μm from a supplying capillary. Angiogenesis and revascularization can facilitate in situ formation of blood vessel networks in tissue constructs to improve nutrients delivery and distribution. Spatial control of angiogenesis process is difficult, and full revascularization takes months to complete. Dynamic culture using various engineered bioreactors can be alternatives to enhancing mass transfer and reinstating the in vivo physiological fluidics in vitro. In these systems, fluid is driven from the surface layers into the inner core of tissue constructs via convective transport or a pressure gradient. The construct surface experiences greater unremitting flow and shear than the inner core, creating a gradient in the hemodynamic environment across the construct, which is typically not experienced by cells in vivo.

Thus, a consistent delivery of nutrients via a continuous perfusion circuit through the interconnected pores of the scaffold is important to ensure cell survival throughout the entire tissue engineered construct for optimal structural and functional maintenance. For some tissues such as liver that naturally depend on microcirculation in vivo, the engineered internal flow in tissue constructs can reinstate more controllable hemodynamics to mimic the physiological cellular responses to their surrounding microenvironment. Consequently, many recent tissue engineering research efforts have focused on reconstructing microcirculation structures within scaffolds to facilitate uniform nutrients delivery into the entire scaffold. Reconstruction of such scaffold constructs in a consistent and reproducible manner has been complicated and challenging.

### SUMMARY OF THE INVENTION

Accordingly, the applicants have succeeded in devising a novel tissue culture and/or perfusion technique that exploits the inherent tissue matrix and angio-architecture of tissue slices and concurrently, enables, for example, long-term maintenance of viable, functional cells. This technique utilizes micro-fabricated needles as a perfusion platform to interface with the existing micro-vasculature of tissue slices. For example, liver slices and micro-needles can be embedded in between a PDMS membrane and glass cover slip to sustain adequate pressure within the tissue slice. Utilization of tissue slices provides, for example, the advantage of cellular heterogeneity and interactions within an intact cellular matrix. Integration of micro-needles can, for example, serve as a substitute for the larger preceding vasculatures that supplements nutrients to the cells. Also, for example, the flow rate and/or pressure of the inlet fluids and nutrients can be controlled or adjusted to allow uniform distribution of fluids and nutrients to the tissue sample via inherent pathways. Such control can also, for example, serve to reinstate the inherent hemodynamic environment of the tissue. For example, in the case of liver tissues, by controlling the flow rate and pressure of the inlet fluids and nutrients, the present system not only can allow for uniform distribution of nutrients to the entire construct via inherent sinusoidal pathways, but also the reinstatement of the inherent hemodynamic environment of the liver.

The invention provides a tissue system (or a tissue handling, culturing and/or perfusion system/device) that includes a chamber for containing the tissue, an outlet port fluidly coupled to the chamber, an inlet port fluidly coupled to the chamber and a micro-needle. The micro-needle includes a lateral first aperture and a tip end with a second aperture. The micro-needle is arranged in the tissue system, in such a way that the tip end of the micro-needle is positioned about the inlet port. The first and the second aperture are configured for injecting a fluid into a portion of the tissue.

The invention further provides a method of perfusing a tissue contained by a chamber of a tissue system. The tissue system includes an outlet port fluidly coupled to the chamber, an inlet port fluidly coupled to the chamber, and a micro-needle. The micro-needle includes a lateral first aperture and a tip end with a second aperture. The micro-needle is arranged in the tissue system, in such a way that the tip end of the micro-needle is positioned about the inlet port. The method includes injecting a fluid through the micro-needle into a portion of the tissue.

### BRIEF DESCRIPTION OF THE DRAWINGS

The skilled artisan will understand that the drawings, described below, are for illustration purposes only. The drawings are not intended to limit the scope of the present teachings in any way.

FIG. 1 shows an exemplary system of the invention that is used in Example 1.

FIG. 2 is an illustration of a 2 mm thick tissue slice perfused with 10% Trypan Blue for 5 minutes using a single 30G needle. A: Top of the tissue, B: bottom of the tissue and C: cross-sections of the tissue at the needle puncture point.

FIG. 3 is an illustration of a 2 mm thick tissue slice perfused with 10% Trypan Blue for 5 minutes using a single 30G needle. A: Bottom of the tissue (completely perfused), B: Top of the tissue, C: schematic of cross section, D: Cross section A (L), E: Cross section A (M), F: Cross section B (M) and G, H: Cross section B (R).

FIG. 4 is an illustration of incubation systems; A: stationary system, B: rocker dynamic organ culture.

FIG. 5 is an illustration of the effect of different incubation systems (stationary system and rocker system) using MTT assay. Slices were perfused with UW solution, precision-cut to 300 μm using Krumdieck slicer and pre-incubated for 1 hr.

FIG. 6 is an illustration of a 300 μm thick tissue stained with 100 uM Rho 6G and captured using confocal microscopy (excitation: 543 nm and emission: 560 nm). Each stack is 150 μm with optical sections captured every 2 μm. (A) and (C) were stained under rocking conditions and (B) and (D) were stained under static diffusion condition. (A-B) Images obtained from the bottom layer of the tissue and (c-d) Images obtained from the top layer of the tissue.

FIG. 7 is an illustration of a 2 mm thick tissue stained with 100 μM Rho 6G and captured using confocal microscopy (excitation: 543 nm and emission: 560 nm). Each stack is 150 μm with optical sections captured every 2 μm. (A) and (C) were stained using single needle perfusion and (B) and (D) were stained under rocking conditions. (A-B) Images obtained from the bottom layer of the tissue and (C-D) Images obtained from the top layer of the tissue.

FIG. 8 is an illustration of A) micro-needle chamber components; B) Part 1—Base; C) Part 2—PDMS membrane; D) Part 3—micro-needle platform; E) Part 4—Top cover.

FIG. 9 is a schematic representation and assembly diagram of the micro-needle apparatus.

FIG. 10 is micro-needle apparatus set-up.

FIG. 11 is an illustration of 900 μm liver slices perfused with 10% Trypan Blue; A: Top of the liver slice; B: Bottom of the liver slice, showing the cutting line of the cross section; C: Left side of the liver slice (L); D: Right side of the liver slice (R). Small arrows show regions that remain to be perfused.

FIG. 12 is an illustration of 900 μm liver slices perfused with 10% Trypan Blue; A: Top of the liver slice; B: Bottom of the liver slice, showing the cutting line of the cross section; C: Left side of the liver slice (L); D: Right side of the liver slice (R). Small arrows show regions that remain to be perfused.

FIG. 13 is a multi-needle chamber designed for intra-tissue perfusion (ITP). (A) Perfusion chamber assembly and (B) schematic diagram. Reference numerals in both figure parts are: 1, top cover; 2, needle platform; 3, adjustable brace; 4, lower cover; 5, tissue. (C) ITP system. (D) Seven-needle configuration platform. X and Y are the cross-sections taken to evaluate propidium iodide (PI) distribution.

FIG. 14 depicts confocal images of the cross-sections of 1 mm tissues stained under static culture and seven-needle intra-tissue perfusion (ITP) configuration. Images were visualized using confocal microscopy (LSM META 510, Carl Zeiss) with excitation of 488 nm and emission of 500-500 nm for gray channel (fluorescein), and excitation of 543 nm and emission of 565-615 nm for red channel (PI). (A, B) Static; (C, D) seven-needle ITP at 1.0 mL/min. (A) and (C) are images of the cross-section X (approximately 2 mm off center), whereas (B) and (D) are images of the cross-section Y (at the center of the tissue). Bar: 500 μm.

FIG. 15 depicts five-micron paraffin-embedded slices stained with H&E on tissue slices. (A, B) 300 μm and 1 mm slices at time 0, respectively. (C, D) 300 μm slices after 1-day and 3-day static cultures, respectively. (E, F) 1 mm slices after 1-day and 3-day static cultures, respectively. (G, H) 1 mm slices after 1-day and 3-day seven-needle intra-tissue perfusion (ITP) cultures, respectively. Bar: 200 μm.

FIG. 16 shows the cell viability of liver slices measured by live/dead assay using C12-resazurin for live staining (grey) and SYTOX Green for dead staining (green). Images shown are maximum intensity projections of a z-stack captured using confocal microscope. (A, D, G) 300 μm slices at 0 h, 1-day static culture, and 3-day static culture, respectively. (B, E, H) 1 mm slices at 0 h, 1-day static culture, and 3-day static culture, respectively. (C, F, I) 1 mm slices at 1.0 mL/min at 0 h, 1-day culture, and 3-day culture using seven-needle intra-tissue perfusion (ITP) culture, respectively. Bar: 100 μm.

FIG. 17 shows phase I metabolic activities of liver slices cultured under static and intra-tissue perfusion (ITP) conditions. Metabolic activities were measured by evaluating resorufin-O-deethylase activity (CYP 1A activity). Images shown are maximum intensity projections of a z-stack captured using confocal microscope. (A, D, G) 300 μm slices at 0 h, 1-day static culture, and 3-day static culture, respectively. (B, E, H) 1 mm slices at 0 h, 1-day static culture, and 3-day static culture, respectively. (C, F, I) 1 mm slices at 1.0 mL/min at 0 h, 1-day culture, and 3-day culture using seven-needle ITP culture, respectively. Bar: 100 μm.

FIG. 18 (A) is the quantification of cell viability of liver slices cultured under static conditions and intra-tissue perfusion (ITP) conditions over 3 days using AlamarBlue assay. Each bar represents mean±SEM (*p<0.10, **p<0.05). FIG. 18 (B) shows phase II metabolic activities of liver slices cultured under static and ITP conditions. Metabolic activities were measured by evaluating the production of 4-methylumbelliferone glucuronide (UDP-glucuronyl transferase activity). Each bar represents mean±SEM (**p<0.05).

FIG. 19 is the characterization of liver-specific functions of liver slices cultured under static and intra-tissue perfusion (ITP) conditions over 3 days represented by (A) albumin synthetic function and (B) urea synthetic function. Each bar represents mean±SEM (*p<0.10, **p<0.05).

FIG. 20 is a mechanical drawing of porous needles design

FIG. 21 depicts fabricated porous needles.

FIG. 22 shows further embodiments of porous needles that may be used in the present invention (2=tip end with aperture, 3=wall of the needle, 4=inner channel of the needle, 5=lateral aperture).

FIG. 23 depicts a porous needle setup for culturing large tissue constructs, A. Porous needle platform, arrows indicate the region where the needles are embedded, B. Enlarged view of porous needles embedded in the needle platform. C. Stereo image of porous needles used for culturing large tissue constructs in the ITP.

FIG. 24 provides scanning electron microscope images of PCL-collagen scaffolds seeded with hepatocytes and cultured under A. ITP perfusion system, B. Static system; for 24 hr. Arrows indicate the locations of cell aggregates.

FIG. 25 is a characterization of urea synthetic functions of hepatocytes seeded onto PCL-collagen scaffolds cultured under static and ITP conditions over 9 days Each bar represents the mean±standard deviation. (*p<0.05)

FIG. 26 is a characterization of albumin synthetic functions of hepatocytes seeded onto PCL-collagen scaffolds cultured under static and ITP conditions over 8 days Each bar represents the mean±standard deviation. (*p<0.05)

FIG. 27 shows the viability of hMSC seeded onto PCL-collagen scaffolds cultured under static and ITP conditions over 7 days Each bar represents the mean±standard deviation. (*p<0.05)

### DETAILED DESCRIPTION OF THE INVENTION

Thus, in certain aspects, the present invention offers a solution to the mass transfer limitation conundrum that had plagued the field of tissue slice engineering for many years. In some aspects, the present invention provides a higher level of biomimicry by exploiting existing inherent extracellular matrix and microvasculature of a tissue such as, for example, the liver. In some aspects, the present invention excludes the necessity of cell isolation and stimulation of cells to maintain high functionality with a variety of growth factors, scaffold design, and co-culture. Micro-needle perfusion enhances the uniform distribution of perfusion media, which subsequently ameliorates the viability and functionality of the tissue over a long-term culture. (Example 1 and 2). Micro-fabrication techniques enable design and development of a range of micro-needles with varying size, array distance and shape, which permits the versatility of experimental designs. Utilization of micro-needles can potentially facilitate the introduction of different drugs at different regions of the liver, and investigate the interactions of the cells from different regions with respect to the drugs introduced.

The current invention marks the inauguration of a living tissue biochip with the advantages of a compact, high throughput platform and with at least the following applications, for example:

Platform for ADME/Tox Investigations and High Throughput Screening (HTS)

ADME/tox is concerned with how various factors, such as a drug, for example, are adsorbed, distributed, metabolized, and/or eliminated and any harmful or toxic properties of a factor and its metabolites. For example, the application of liver slices in ADME/tox studies can be an experimental tool. However, culture of liver slices over a period of time can be unfeasible due to necrotic tissues in the central region of the tissue slice as a result of mass transfer limitations. The current invention can provide a solution to this problem and hence, creates a new paradigm to ADME/tox experimental designs.

Historically, due to the short life-time of tissue slices, drug toxicity tests were conducted in non-physiologically high dosage. Such tests only offer a very superficial understanding of the actual drug metabolism. The introduction of a long-term tissue biochip enables experimental designs that utilize more realistic and physiological dosage and thus, allows more in-depth studies to be performed.

The micro-needles system can also be used to inject different pharmaceutical biomolecules into different parts of the tissue, creating a differential concentration and type of drugs within the same tissue slice. This technique can assist the understanding of interaction between different kinds of chemicals and how these chemicals affect living tissue by being differentially distributed in different parts of the slice.

The technology of micro-fabrication also offers the possibility of integrating in situ and real-time sensors, which can detect hormones, oxygen levels, ligands and chemical agents.

Chip-based systems can be easily duplicated and multiplexed, facilitating the integration of HTS to screen potential pharmaceutical products. Such systems offer the advantage of speed, flexibility and accuracy in evaluating the pharmacokinetics of a particular drug.

Tissue Biochip for Bioimaging and Biological Investigations

Utilization of a thick tissue that is embedded in between a transparent PDMS membrane and cover slip permits the incorporation of confocal microscopy and multiphoton microscopy as a bioimaging tool. Integration of these experimental techniques along with the current chip-based tissue enables at least the following applications, for example:
(i) By using micro-needles to interface with the existing angio-architecture of the liver slice, it is possible to observe the metabolism of a drug in an in vivo environment to the extent of a single cell resolution. The entire biotransformation and transport pathway of a single or multiple fluorescent-tagged biomolecule can be tracked and imaged online and in real-time.
(ii) Since a tissue slice retains the complex tissue matrix and cell heterogeneity, the interactions between different cell types can be observed. In addition, the interactions and in vivo dynamic cellular changes in the introduction of a foreign substance such as drugs or metastatic cancer cells can be observed.
(iii) Since micro-needles offer the advantage of differential introduction of multiple drugs, this chip-based device can be used to observe not only the effect of the drugs at a specific region, but also the interaction of cells with the drug and among different cell types at the interface region.

Tissue Microarrays

This chip-based device can be multiplexed to form tissue microarrays (TMA). TMA is normally used for high throughput histological studies, however, existing TMA utilizes thin sections of fixed tissues. The current device can also be used for similar applications with the advantage of thicker tissue sections and also viable, functional tissues. This advantage presents many applications such as, for example:
(i) Viable tissue sections can be cryopreserved and commercially marketed. Viable and functional tissues preserved this way enable off-the-shelf availability of tissue chips for experiments, avoiding the need for cell or tissue isolations. This not only permits histological studies, but also functional studies.
(ii) Thin tissue sections were traditionally preferred due to inability to uniformly stain the entire tissue. With the current invention using micro-needles perfusion, this problem can be eliminated.

Cell Culture Analogues

Besides using the liver as a sample source, the current technique can also be extended to other organs of the body such as the lung and the kidneys. In the past, cell culture analogues (CCA) of the body had been created using in vitro cell culture flasks containing different parenchymal cells obtained from vital parts of the body. A chip-based CCA has also been introduced recently with the benefit of physiologically representative flowrates and shear forces [Sin et al. (2004); Biotechnology Progress; 20; pp. 338-345]. A similar CCA can be created using the current technique, i.e. isolating representative tissue slices from vital parts of the body such as the liver, lungs and kidneys and interfacing these tissues slices via micro-needles. The advantage of this tissue chip-based CCA relative to previous designs is the utilization of a highly biomimicry cellular construct comprising both parenchymal and non-parenchymal cells.

Engineering Large Tissue Constructs

By adjusting the densities and the length of micro-needles, we can culture tissue slices, and engineered tissue constructs of much larger dimensions (thicker and bigger) than currently possible. In the current culture configurations (either static or dynamic), tissues or tissue constructs larger than 1 mm typically disintegrate rapidly due to limited mass transfer through these pieces of tissue constructs. Perfusion through micro-needles can be precisely controlled to provide nutrients and remove metabolic wastes for efficient functions of cells and maintenance of structural integrity of tissues or tissue constructs of large dimensions >1 mm.

The invention provides a tissue system, which may be any apparatus, device or arrangement, assembly or configuration of devices suitable for perfusing a tissue. The tissue system may accordingly also be addressed as an apparatus for handling, culturing and/or perfusion of a tissue. The tissue system may be designed to accommodate any desired tissue. A respective tissue may be any tissue, for example a tissue obtainable or obtained from an organism, such as an animal, e.g. a mammalian species, including a rodent species, an amphibian, e.g. of the subclass Lissamphibia that includes e.g. frogs, toads, salamanders or newts, an invertebrate species, or a plant. Examples of mammals include, but are not limited to, a rat, a mouse, a rabbit, a guinea pig, a squirrel, a hamster, a hedgehog, a platypus, an American pika, an armadillo, a dog, a lemur, a goat, a pig, an opossum, a horse, a bat, a woodchuck, an orangutan, a rhesus monkey, a woolly monkey, a macaque, a chimpanzee, a tamarin (saguinus oedipus), a marmoset or a human. An illustrative example of a tissue is an organ or a portion thereof, such as adrenal, bone, bladder, brain, cartilage, colon, eye, heart, kidney, liver, lung, muscle, nerve, ovary, pancreas, prostate, skin, small intestine, spleen, stomach, testicular, thymus, tumor, vascular or uterus tissue, or connective tissue.

The tissue may also be a tissue slice or an engineered tissue construct. In some embodiments such a tissue construct may be engineered in the tissue system. Accordingly, in some embodiments the tissue system may be used to form a tissue, for instance from a plurality of cells. For this purpose the tissue system may include a scaffold, geometric elements such as microchannels or other means that assist or serve in the formation of a three-dimensional tissue from individual cells (see also below). In the tissue system of the invention a tissue, including a tissue slice, may be used for any desired purpose, including e.g. the testing of an effect of a factor (e.g. a compound) included in a fluid used for perfusion (see also below). In some embodiments a plurality of tissues (including tissue slices) is included in a tissue system according to the invention. In some embodiments a plurality of tissue systems are used, e.g. in parallel. As an illustrative example, a tissue micro array, which is a plurality of tissue samples arrayed in organized fashion, may be included in one or more tissue systems according to the present invention. The use of a tissue micro array, which may be employed for screening purposes, including high-throughput analysis, has so far been limited to arrays of miniature core biopsies. While these can also be used in the tissue system of the present invention, over a longer period of time than so far achievable, larger tissues or tissue pieces can likewise be handled as also explained above and below. Thereby the present invention overcomes a downside of conventional tissue micro arrays of miniature core biopsies, which is the inherent problem that a small core not necessarily reflects the whole tissue section. Intratissue heterogeneity, in particular in the case of tumor tissue, cannot be taken into account with a core biopsy.

The tissue system includes a chamber. The chamber is generally defined by a circumferential wall and a base. The base may be removable and in such cases also be referred to as a bottom cover or lower cover. Furthermore, the chamber typically has a top cover (or upper cover) at least essentially opposite the base. A top of the chamber is typically oriented toward the inlet of the tissue system. The same applies to the terms “on top”, “above” as used herein in this context. The system may further include a housing defining the chamber. The chamber is, or is capable of being, cut-off from the external environment, for example by closing a top-cover or a lid. The term “environment” refers to the exterior (vs. the interior) of the chamber and therefore means any matter that is not located inside or contacting the interior of the chamber. It thus refers to any space or matter that is not in direct contact with fluid filled into the chamber while the chamber is closed. Hence, the environment includes further elements of the system of the invention. One such element may be a device coupled to or connected to the inlet port or the outlet port of the tissue system, such as a channel or a pipeline, e.g. a tubing, or a reservoir.

The chamber, a part or portion thereof or a housing defining the chamber may include, or consist of any desired material as long as a desired integrity or stability of the chamber is provided. Suitable materials include, but are not limited to, a metal, a metalloid, ceramics, a metal oxide, a metalloid oxide, oxide ceramics, carbon, wood, stone, and a polymer (see below for examples). As an illustrative example, the chamber or a respective housing may include or consist of a polydimethylsiloxane (PDMS) membrane, polycarbonate and/or a biodegradable polymer (see below for further examples).

In some embodiments the tissue system includes a plurality of chambers. A plurality of chambers is in some embodiments fluidly coupled. In some embodiments the tissue system includes a housing that defines a plurality of chambers. Each of the chambers may be configured for containing one or more tissues. In some embodiments each of a plurality of chambers includes one or more outlet ports and one or more inlet ports. Each of such outlet ports and/or inlet ports may be fluidly coupled to any selected number of a corresponding plurality of chambers, including all chambers.

The chamber may include further devices or elements such as a brace, a needle-platform, or a positioning element. In some embodiments the chamber and a top cover form one physical unit. In some embodiments the chamber, a brace and a needle-platform form one physical unit, which in some embodiments additionally encompasses a top cover. In some embodiments the chamber further includes a sealing element affixed to the chamber in a manner to maintain a desired fluid, for instance a liquid, in the chamber, i.e. to remain impermeable for the fluid contained therein. In some embodiments the sealing element hermetically seals the sample processing chamber from the environment once and as long as the inlet port and the outlet port of the tissue system are likewise hermetically sealed from the environment. In other embodiments the sealing element is permeable for fluid that is not of interest for a desired process to be carried out in the chamber, such as for instance a gas. In one embodiment, the sealing may occur by way of adding adhesives or sealing gels, for example to the periphery of the sealing layer to obtain an airtight fit between the sealing layer and the chamber. In other embodiments, the sealing layer may be attached to the chamber either mechanically (by pins or stitching) or by a snap-fit or tight-fit mechanism.

The chamber may possess any internal surface characteristics, as long as they allow the chamber to accommodate, including contain, a tissue. The inner surface(s) of the circumferential wall, the base, as well as a top-cover may thus for instance be either hydrophilic or hydrophobic. Furthermore, different internal areas of surface portions may provide different surface characteristics. Thus, some areas, such as walls or wall-portions, may be hydrophilic, while others may be hydrophobic. Any part of the inner surface of the chamber may also be treated in such a way that it provides respective hydrophilic or hydrophobic surface characteristics. For example a base may be treated respectively.

A treatment of a surface facing the interior of the chamber or any other part of the chamber or of the tissue system that achieves an alteration of surface characteristics may be any treatment that leads to an alteration of the respective surface characteristics that lasts long enough for a subsequent accommodation of tissue or a fluid sample to be affected. Typically, this treatment does not affect the composition of tissue contacting the respective surface area. In some embodiments the treatment does further not affect the composition of fluid that contacts the respective surface area.

Treatment that may be carried out to alter surface characteristics may comprise various means, such as mechanical, thermal, electrical or chemical means. A method that is commonly used in the art is a treatment with chemicals having different levels of affinity for the sample fluid. As an example, the surface of plastic materials can be rendered hydrophilic via treatment with dilute hydrochloric acid or dilute nitric acid. As another example, a polydimethylsiloxane (PDMS) surface can be rendered hydrophilic by an oxidation with oxygen or air plasma. Alternatively, the surface properties of any hydrophobic surface can be rendered more hydrophilic by coating with a hydrophilic polymer or by treatment with surfactants. Examples of a chemical surface treatment include, but are not limited to exposure to hexamethyldisilazane, trimethylchlorosilane, dimethyldichlorosilane, propyltrichlorosilane, tetraethoxysilane, glycidoxypropyltrimethoxy silane, 3-aminopropyltriethoxysilane, 2-(3,4-epoxy cyclohexyl)ethyltrimethoxysilane, 3-(2,3-epoxy propoxyl)propyltrimethoxysilane, polydimethylsiloxane (PDMS), γ-(3,4-epoxycyclohexyl)ethyltrimethoxysilane, poly(methyl methacrylate) or a polymethacrylate co-polymer, urethane, polyurethane, fluoropolyacrylate, poly(methoxy polyethylene glycol methacrylate), poly(dimethyl acrylamide), poly[N-(2-hydroxypropyl)methacrylamide] (PHPMA), α-phosphorylcholine-o-(N,N-diethyldithiocarbamyl)undecyl oligoDMAAm oligo-STblock co-oligomer (Matsuda, T et al., Biomaterials, (2003), 24, 24, 4517-4527), poly(3,4-epoxy-1-butene), 3,4-epoxy-cyclohexylmethylmethacrylate, 2,2-bis[4-(2,3-epoxy propoxy) phenyl] propane, 3,4-epoxy-cyclohexylmethylacrylate, (3′,4′-epoxycyclo- hexylmethyl)-3,4-epoxycyclohexyl carboxylate, di-(3,4-epoxycyclohexylmethyl)adipate, bis-phenol A (2,2-bis-(p-(2,3-epoxy propoxy)phenyl)propane) or 2,3-epoxy-1-propanol.

Any surface of the tissue system, including the chamber, e.g. a surface facing the chamber, may have any desired geometric surface characteristics. A respective surface may for instance have inversions, grooves or dents. The chamber may be of any desired dimension and shape. Typically size and shape will be selected to allow convenient handling of a tissue to be contained therein. A cross section of chamber may be of any shape, e.g. a polygon, including a regular polygon, or round, e.g. circular, semicircular or oval, including egg-shaped.

If desired, any part of the tissue system, including the chamber, the chamber cover of a needle-holder, may include or be of translucent material such as, glass, quartz or a plastic material. Suitable plastic materials include, but are not limited to, polymethylmethacrylates (e.g. polymethyl-methacrylate (PMMA), styrene methylmethacrylate copolymer (SMMA), carbazole based methacrylates and dimethacrylates or a polyacrylate or -methacrylate with an alkoxysilane functionality), polystyrene, polycarbonate, poly(allyl carbonate) such as poly(allyl diglycol carbonate) (Columbia Resin 39) and polycyclic olefins such as cyclo olefin copolymer (COC). Examples of further corresponding polymers are embodiments of polyethylene terephthalate, polypropylene (PP homoplymer and copolymer), polystyrene, ethylene-vinyl acetate, polyethylene including, high density polyethylene and, low density polyethylene, transparent acrylonitril butadiene styrene, polyvinylchloride styrene acrylonitrile, polyether sulphone, thermoplastic polyurethane, polyamide, perfluoro-alkoxyalkane and polyethylene imine. A further illustrative example of a material that is additionally suitable for the generation of a substrate that allows light to pass only to a certain extent is fluoro-ethylene-propylene (FEP). Any respective material may also include a dye, a pigment, e.g. of inorganic additives such as calcium carbonate, titanate, barium sulphate, zeolite or titanate/silicate hybrid particles or other additives.

The tissue system further includes an inlet port and an outlet port, herein also referred to as an inlet and an outlet. These inlet and outlets may be of any form, thus for instance forming an entrance or exit connection joint. Examples of such an inlet and outlet, respectively, include, but are not limited to, openings, valves, chambers, necks or channels. Where a channel is provided, such channel may also be branched. Furthermore, such a channel may provide bevelled portions. In embodiments where the tissue system includes more than one chamber, the respective chambers may be connected in parallel and or perpendicular with the inlet and/or outlet. In embodiments where a plurality of inlets and outlets is provided these may be selected in shape, form and function individually. They may thus for instance differ in their geometrical and surface properties. In embodiments where they provide for instance valves, necks or channels, they may thus also be orientated in different angles relative to each other.

The one or more of such inlets and outlets of the tissue system are fluidly coupled, e.g. fluidly connected, to the chamber. They may for instance be coupled to the inlet and outlet via channels or tubing. The inlet port is typically fluidly coupled to the chamber via one or more needles, which may be removable from the tissue system. The needle(s) may be fluidly coupled to the inlet port via any desired element or device, such as tubing, a channel or a chamber. In some embodiments the inlet port, the chamber, and the outlet port are configured to provide a continuous flow of fluid through the tissue. Thus in some embodiments the tissue system includes, or is coupled to, means for achieving a flow of fluid. The recirculating system may for instance include a pump or a similar device capable of providing a continuous flow. The continuous flow may have any desired flow rate. It may be desired to select a flow rate that leaves the tissue intact or that does not substantially, not significantly, or not at all interfere with the integrity, the biological function or the physiological characteristics of the tissue. In one embodiment the continuous flow has a flow rate substantially equivalent to an in vivo hemodynamic flow rate. In one embodiment the continuous flow has a pressure that is substantially equivalent to an in vivo hemodynamic pressure.

In some embodiments the continuous flow of fluid through the tissue is adjustable to a predetermined setting. The tissue system may for example include a control means to maintain or adjust a continuous flow of fluid through the sample. The control means may for example be able to reduce or increase a continuous flow, or to keep it at a predetermined value. If desired, the continuous flow of fluid may be achieved by means of recirculation. Accordingly, in some embodiments the tissue system includes a recirculating system configured for providing a recirculating flow of the continuous flow. The inlet and the outlet are typically fluidly coupled to a recirculating system configured for providing a recirculating flow. Via the recirculating system the outlet may be fluidly couple to the inlet of the tissue system. A respective recirculating system may include one or more reservoirs, a replenishment means, a discharging means, and access points, e.g. for introducing or removing matter.

As noted above, the tissue system includes one or more micro-needles. Such a micro-needle may be of any desired shape, length and inner width, such as inner diameter. The needle may for example have an inner width from about 10 μm to about 1000 μm, such as about 10 μm to about 500 μm, about 5 μm to about 500 μm, about 10 μm to about 300 μm, about 20 μm to about 300 μm, about 5 μm to about 150 μm, about 10 μm to about 150 μm, about 15 μm to about 150 μm, about 5 μm to about 100 μm, about 10 μm to about 100 μm, about 20 μm to about 100 μm, or about 25 μm to about 200 μm, such as e.g. about 30 μm, about 40 μm, about 50 μm, about 60 μm, about 70 μm, about 80 μm, about 90 μm, about 100 μm, about 110 μm or about 120 μm. Illustrative examples of suitable needles that are available commercially, and that can be used in the present invention (for example, after forming the least one lateral aperture) are a 50 μm ID (35 G) needle, 80 μm ID (34 G) needle, a 100 μm ID (33 G) needle, a 114 μm ID (32 G) needle and a 127 μm ID (31 G) needle. The micro-needle(s) may include a tip end and a base end. The base end is typically configured for serving as an inlet, while the tip end is typically configured as an outlet. Both the base end and the tip end of the micro-needle include an aperture (see also below). The tip-end of a micro-needle arranged in the tissue system of the invention may be positioned about the associated inlet port. It may further be configured for injecting a fluid into a portion of a tissue, such as one or more tissues that are positioned into the tissue system.

In embodiments where a plurality of micro-needles is included in the system, they may be fluidly coupled. The micro-needles may be arranged in a micro-needle portion. They may for example be attached thereto or connected thereto or form a physical unit therewith. In some embodiments the micro-needles are removable from the micro-needle portion. The micro-needle portion may be of any material. It may for instance be of a material such as a polymer that renders it capable of sealing the chamber. It may be flexible or elastic to an extent that it may allow penetration by a micro-needle. In some embodiments the micro-needle portion is capable of sealing the chamber when the micro-needle is arranged therein, provided the micro-needle is detained from having a fluid connection to the ambience. In some embodiments the micro-needle portion is capable of sealing the chamber both with a micro-needle arranged therein and without a micro-needle arranged therein. In some embodiments the micro-needle portion may be defined by the top cover. The micro-needle portion may also be coupled between the top cover and the base of the chamber and wherein the chamber is formed by the coupling of the top cover, micro-needle portion and the base.

In embodiments where the tissue system includes a plurality of chambers, each chamber may include one or more micro-needles. The one or more micro-needles may be associated with each inlet port and chamber. Each of the micro-needles may include each a tip end and a base end, with the tip-end being positioned about the associated inlet port and configured for injecting a fluid into a portion of the one or more tissues.

The needle(s) used may be of any desired material, as long as it provides stability to the needle, in particular in terms of mechanical properties, such as strength and stiffness, that allows it to remain at least essentially intact for the time period during which it is intended to provide nutrients and oxygen to the tissue. It may furthermore in some embodiments be desired to select a material that releases no or insignificant amounts of substances, e.g. of the respective material or decomposition products thereof, for a predefined period of time, Examples of a suitable material include, but are not limited to, a metal, a metalloid, ceramics, a metal oxide, a metalloid oxide, oxide ceramics, carbon and a polymer. Examples of suitable metalloids include, but are not limited to silicon, boron, germanium, antimony and composites thereof. Examples of suitable metals include, but are not limited to iron (e.g. steel), aluminum, gold, silver, chromium, tin, copper, titanium, zinc, aluminum, lead and composites thereof. A respective oxide of any of these metalloids and metals may be used as a metalloid oxide or metal oxide respectively. As an illustrative example, the base substrate may be of quartz or a glass. Examples of ceramics include, but are not limited to, silicate ceramics, oxide ceramics, carbide ceramics or nitride ceramics.

As noted above, in some embodiments the needle and/or the chamber, or a portion thereof, may include or consist of a biodegradable material, such as a biodegradable polymer. A biodegradable material is readily susceptible to biological processing in vivo. It can be degraded by a living organism or a part thereof (e.g., bacterial or enzymatic action) or by the impact of the ambience, such as exposure to light, moisture, elevated temperature and/or air. Degradation of a biodegradable material may result in the formation of primary degradation products such as compounds of low molecular weight, which then decay further through the action of a living organism. In the context of the present invention the term “biodegradable material” particularly refers to matter that can be completely removed from a localized area, by physiological metabolic processes. A “biodegradable” compound can, when taken up by a cell such as a cell of a tissue, be broken down into components by cellular machinery such as lysosomes or by hydrolysis that the cells can either reuse or dispose of without significant toxic effect on the cells. Examples of biodegradation processes include enzymatic and non-enzymatic hydrolysis, oxidation and reduction. Suitable conditions for non-enzymatic hydrolysis, for example, include exposure of biodegradable material to water at a temperature and a pH of a lysosome (i.e. the intracellular organelle). The degradation fragments typically induce no or little organ or cell overload or pathological processes caused by such overload or other adverse effects in vivo. Generally a biodegradable polymer can be degraded by cells at temperatures up to 50° C., in typical embodiments over a period of several months to one year. It may in some embodiments be desirable to select a biodegradable material with non-toxic degradation products. An overview on the physiological parameters to be considered and suitable test methods in terms of biocompatibility has been given by Burg et al. (in: Absorbable and Biodegradable Polymers (2004), S. W. Shalby & K. J. L. Burg (eds,), CRC press, Boca Raton, Fla., Chapter 10: Polymer Biocompatibility and Toxicity).

Various examples of biodegradable materials are known in the art, any of which are generally suitable for use in the method of the present invention. As some illustrations of polymers that are considered to be biodegradable may serve: a polyglycolide, a polylactide, a polycaprolactone, a polyamide, a biodegradable aliphatic polyester, and/or copolymers thereof, with and without additives (e.g. calcium phosphate glass), and/or other copolymers (e.g. poly(caprolactone lactide), a poly(ester amide), a poly(amino acid), a pseudo-poly(amino acid) such as a poly(iminocarbonate-amide) copolymer, poly(lactide glycolide), poly(lactic acid ethylene glycol), poly(lactic acid-glycolic acid-4-hydroxyproline), poly(ethylene glycol), poly(ethylene glycol) diacrylate, a polyalkylene succinate, polybutylene diglycolate, a polyhydroxybutyrate, polyhydroxyvalerate, a polyhydroxybutyrate/polyhydroxyvalerate copolymer; poly(hydroxyl-butyrate-co-valerate); a polyhydroxyalkaoates, a poly(caprolactone-polyethylene glycol) copolymer, poly(valerolactone), a polyanhydride, a poly(orthoester) and/or a blend with a polyanhydride, poly(anhydride-co-imide), an aliphatic polycarbonate, a poly(propylene carbonate), a poly(hydroxyl-ester), a polydioxanone, a polyanhydride ester, a polycyanoacrylate, a poly(alkyl cyanoacrylate), a poly(amino acid), a poly(phosphazene), a poly(propylene fumarate), poly(propylene fumarate-co-ethylene glycol), a poly(fumarate anhydride), fibrinogen, fibrin, gelatin, cellulose, a cellulose derivative, chitosan, a chitosan derivative such as chitosan NOCC, chitosan NOOC-G or NO-carboxymethyl chitosan NOCC, alginate, a polysaccharide, starch, amylase, collagen, a polycarboxylic acid, a poly(ethyl ester-co-carboxylate carbonate), poly(iminocarbonate), poly(bisphenol A-iminocarbonate), poly(trimethylene carbonate), poly(ethylene oxide), poly(epsilon-caprolactone-dimethyltrimethylene carbonate), a poly(alkylene oxalate), poly(alkylcarbonate), poly(adipic anhydride), a nylon copolyamide, carboxymethyl cellulose; copoly(ether-esters) such as a PEO/PLA dextran, a biodegradable polyester, a biodegradable polyether, a polydihydropyran, a biodegradable polyketal such as poly (hydroxylmethylethylene di(hydroxymethyl) ketal) or poly [1-hydroxymethyl-1-(2-hydroxy-1-hydroxymethyl-ethoxy)-ethylene oxide], a polydepsipeptide, a polyarylate (L-tyrosine-derived) and/or a free acid polyarylate, a poly(propylene fumarate-co-ethylene glycol) such as a fumarate anhydride, a hyaluronate, poly-p-dioxanone, a polyphosphoester, polyphosphoester urethane, a polysaccharide, starch, rayon, rayon triacetate, latex, and/or copolymers, blends, and composites of any of the above.

A review on the formation and currently achievable properties of polylactide has for example been given by Gupta & Kumar (European Polymer Journal (2007) 43, 10, 4053-4074). As the chamber of the tissue system may be of any desired matter (supra), the chamber or a part thereof may likewise include or consist of a biodegradable material. Utilization of a porous biodegradable material can enable the live cells of the tissue to grow into and occupy the porous structure, hence, making it possible to grow a small tissue slice into a larger tissue slab. In particular where a micro-needle with lateral aperture is used, cells of the tissue growing into the porous structure and occupying the same can create cellular conduits mimicry of in vivo vasculature. The use of a needle that is of or includes biodegradable material can thus be used as a bridge to facilitate host scaffold interactions for implantation. The biodegradable material can also be seeded with stem cells or progenitor cells prior to encapsulating the tissue slice. In this configuration, the stem cells or progenitor cells can provide a cell source for proliferation, and the liver slice can provide signals for the cells to differentiate. By using the abovementioned methods to grow a larger tissue slab, it can be used for bioartificial liver and other tissue engineering applications to substitute damaged organ parts. Incorporation of biodegradable materials into a plurality of needles will also enable a respective system to be used as a temporary external microcirculatory system to facilitate integration of tissue construct into a living host.

In embodiments where the tissue system includes a plurality of micro-needles, these micro-needles may be arranged at a certain distance from each other. The distance between some or all individual micro-needles may differ or be at least substantially similar or identical. The distance between individual micro-needles may, for example, be in the range from about 0.2 to about 20 mm, about 0.2 to about 15 mm, about 0.2 to about 10 mm, about 0.5 to about 10 mm, about 0.2 to about 5 mm or about 0.2 to about 2 mm, such as e.g. about 0.5 mm, about 1 mm, about 2 mm, about 3 mm, about 4 mm or about 5 mm. The micro-needles may for instance be arranged in a row. In one embodiment a plurality of micro-needles of the tissue system includes three micro-needles. The three micro-needles of the plurality of micro-needles are arranged at an at least essentially equal distance to each other. Thereby they define an at least essentially equilateral triangle, when viewed from above. In another embodiment four micro-needles are arranged at an at least essentially equal distance, defining a square, when viewed from above. The micro-needles of the plurality of micro-needles may be arranged at an at least essentially equal distance to each other, thereby defining an at least essentially regular polygon, when viewed from above.

In some embodiments the micro-needle includes a lateral first aperture. This lateral first aperture may be designed as a side hole. It may be arranged anywhere along the length of the micro-needle. Such a side hole may be formed using well established standard techniques such as lithography, e.g. photolithography or etching, micro-mechanical drilling or laser-drilling. The tip end of the micro-needle includes a second aperture (supra). In some embodiments the micro-needle includes a plurality of lateral first apertures, which may be arranged anywhere along the length of the micro-needle. The lateral apertures of such a plurality of lateral apertures may of different size and shape, of similar size and shape or of at least essentially the same size and/or at least essentially the same shape. The lateral apertures of a respective plurality of lateral apertures may be independently arranged, for instance in proximity to each other, on opposite sides along the length of the micro-needle or offset. Such needles can be manufactured by Vita Needle Company, Inc., Needham, Mass., for example.

Typically the micro-needle is arranged in the tissue system with its tip end being positioned about the inlet port of the tissue system. The tip end may be fluidly coupled to the inlet port, e.g. via tubing. The micro-needle may be arranged in such a way that tip end of the micro-needle may point away from the inlet port. In some embodiments the tip end of the micro-needle is arranged at least essentially below the inlet port.

In some embodiments the tissue system further includes a membrane portion. The membrane portion may be configured for holding the tissue. The membrane portion may be positioned between the chamber cover and the base of the chamber. In some embodiments the membrane portion is positioned between the micro-needle portion and the base of the chamber.

The present invention also relates to a method of perfusing a tissue contained by a chamber. The method includes injecting a fluid into a portion of the tissue. The fluid is typically a liquid or a gas, e.g. air or an inert gas or a mixture of liquids or gases or of both a gas and a liquid (including nebulized or in form of a solution). A liquid or a gas may include further components that may as such also be solid. A liquid may for instance include organic or inorganic ions, typically in form of salts (e.g. calcium iron, calcium phosphate, calcium carbonate, sodium chloride, potassium chloride, iron chloride, iron nitrate, magnesium sulphate, sodium carbonate, sodium hydrogen carbonate or sodium phosphate), gases (oxygen, nitrogen, carbon dioxide), chelating compounds, buffer compounds, proteins, nucleic acids, enzymes, extracellular matrix components, growth factors, hormones, vitamins, antimicrobial agents such as antibiotics, antimitotics, inhibitors, antithrombogenic agents, thrombolytic agents, fibrinolytic agents, therapeutic agents, vasodilators, antihypertensive agents, saccharides, lipids, amino acids (whether essential or nonessential amino acids), nucleotides, polysaccharides, oligo- or polypeptides, oligo- or polynucleotides, serum, dyes (e.g. phenol red) or any other desired compound or other matter (see also below).

Numerous buffer compounds are used in the art and may be used to carry out the various processes described herein. Examples of buffers include, but are not limited to, solutions of salts of phosphate, carbonate, succinate, citrate, acetate, formate, barbiturate, oxalate, lactate, phthalate, maleate, cacodylate, borate, N-(2-acetamido)-2-amino-ethanesulfonate (also called (ACES), N-(2-hydroxyethyl)-piperazine-N′-2-ethanesulfonic acid (also called HEPES), 4-(2-hydroxyethyl)-1-piperazine-propanesulfonic acid (also called HEPPS), piperazine-1,4-bis(2-ethanesulfonic acid) (also called PIPES), (2-[Tris(hydroxymethyl)-methylamino]-1-ethansulfonic acid (also called TES), 2-cyclohexylamino-ethansulfonic acid (also called CHES) and N-(2-acetamido)-iminodiacetate (also called ADA). Any counter ion may be used in these salts; ammonium, sodium, and potassium may serve as illustrative examples. Further examples of buffers include, but are not limited to, triethanolamine, diethanolamine, ethylamine, triethylamine, glycine, glycylglycine, histidine, tris(hydroxymethyl)aminomethane (also called TRIS), bis-(2-hydroxyethyl)-imino-tris(hydroxymethyl)methane (also called BIS-TRIS), and N-[Tris(hydroxymethyl)-methyl]-glycine (also called TRICINE), to name a few. Two illustrative examples of ionic liquids are 1,3-dialkylimidazolium-tetrafluoroborates and 1,3-dialkylimidazolium-hexafluoroborates. The ionic liquid may be a polar ionic liquid such as for instance 1-ethyl-3-methylimidazolium tetrafluoroborate, N-butyl-4-methylpyridinium tetrafluoroborate, 1,3-dialkylimidazolium-tetrafluoroborate, 1,3-dialkylimidazolium-hexafluoroborate, 1-ethyl-3-methylimidazolium bis(pentafluoroethyl)phosphinate, 1-butyl-3-methylimidazolium tetrakis(3,5-bis(trifluoromethylphenyl)borate, tetrabutyl-ammonium bis(trifluoromethyl)imide, ethyl-3-methylimidazolium trifluoromethanesulfonate, 1-butyl-3-methylimidazolium methylsulfate, 1-n-butyl-3-methylimidazolium ([bmim]) octylsulfate, and 1-n-butyl-3-methylimidazolium tetrafluoroborate. The ionic liquid may be a non-polar ionic liquid such as for instance, 1-ethyl-3-methylimidazolium bis[(trifluoromethyl)sulfonyl]amide bis(triflyl)amide, 1-ethyl-3-methylimidazolium bis[(trifluoromethyl)sulfonyl]amide trifluoroacetate, 1-butyl-3-methylimidazolium hexafluorophosphate, 1-hexyl-3-methylimidazolium bis(trifluoromethyl-sulfonyl)imide, 1-butyl-3-methylimidazolium bis(trifluoromethylsulfonyl)imide, trihexyl(tetradecyl)phosphonium bis[oxalato(2-)]borate, 1-hexyl-3-methyl imidazolium tris(pentafluoroethyl)trifluorophosphate, 1-butyl-3-methyl-imidazolium hexafluorophosphate, tris(pentafluoroethyl)trifluorophosphate, trihexyl(tetradecyl)phosphonium, N″-ethyl-N,N,N′,N′-tetramethylguanidinium, 1-butyl-1-methyl pyrroledinium tris(pentafluoroethyl) trifluorophosphate, 1-butyl-1-methyl pyrrolidinium bis(trifluoromethylsulfonyl) imide, 1-butyl-3-methyl imidazolium hexafluorophosphate, 1-ethyl-3-methylimidazolium bis(trifluoromethylsulfonyl)imide and 1-n-butyl-3-methylimidazolium. In some embodiments the fluid is a culture medium.

The fluid is injected through a micro-needle. In some embodiments a plurality of micro-needles may be used. The tissue system as described above may for instance include a plurality of such needles. In some of these embodiments the fluid is injected through some or all needles of a respective plurality of micro-needles. Micro-needles, in particular micro-needles of a plurality of microneedles through which fluid is injected are in some embodiments fluidly coupled. The present applicants have observed that it may often be advantageous to use a plurality of needles rather than a single needle, since a single needle can imposes a significant high pressure on the cells/tissue, resulting in poor viability performance.

Typically the chamber is included in a tissue system as described above. In some embodiments the micro-needle used in the method includes a lateral aperture (supra). This aperture is herein referred to as the first aperture, and the aperture at the tip end is referred to as the second aperture. The micro-needle is arranged, e.g. removably arranged, in the tissue system, typically with the tip end of the micro-needle being positioned about the inlet port. In some embodiments the method includes arranging the one or more micro-needles in the tissue system. The method may also include arranging the one or more micro-needles in the tissue. In some embodiments the micro-needle(s) is/are is arranged, e.g. inserted into the tissue to an extent that fluid can be perfused and/or injected via both the first and the second aperture of a respective micro-needle. The present applicants have observed that using micro-needles with lateral apertures, e.g. micro holes, along the length of the needles is particularly advantageous to accommodate for the thickness of a scaffold used. By adjusting the densities and the length of microneedles, it is possible to culture thick tissue slices, and engineered tissue constructs of much larger dimensions (in all three dimensions, including thickness and horizontal extension) than currently possible. Instead of an out of plane delivery, such needles deliver nutrients in plane with the scaffold. An array of needles utilized as intra-scaffold perfusion system provides temporary nutrient supply conduits prior to de novo re-vascularization in reconstruction of large tissue-engineered constructs. Such a scheme eases the complexity of the scaffold required for thick tissue culture, and provides the versatility of independently controlling the flow rate and pressure of the system. Furthermore, using such needles, substantially longer culturing periods can be achieved. In preliminary experiments carried out by the applicants using a plurality of micro-needles with lateral apertures a culturing period of 10 days could be achieved.

In some embodiments the method includes letting the fluid flow through the tissue, such as letting the fluid continuously flow through the tissue. The method may also include recirculating the fluid (see above). The method may also include injecting through the micro-needle, such as a micro-needle with a lateral aperture, a fluid into a portion of the tissue, such as a portion that includes or is a sinusoid. The injecting may include contacting a portion of the tissue with a micro-needle that includes a lateral aperture and a tip end positioned about an inlet port fluidly coupled to the chamber.

As noted above, the tissue on which the method is applied may be any tissue. In some embodiments the tissue is a liver tissue and the fluid is injected into a sinusoid. In some embodiments the tissue is a previously preserved tissue, e.g. a cryopreserved tissue. In some embodiments the tissue is an engineered tissue. Such an engineered tissue may be of any structure and form, and be formed by means of a device or element of any desired structure and form, such as a sponge, foam, mesh of fibers, sheet, woven or knitted materials. In some embodiments the tissue is in the stage of formation and thus in the process of tissue engineering. Any respective tissue may be formed in the tissue system of the invention using any desired means, e.g. geometric elements, to establish a tissue of desired function and shape. A tissue formed in, or by means of, the tissue system of the invention may also include any element or device as described above, used e.g. as a support. Such an element or device may include any matter, including e.g. calcium phosphate based ceramics such as hydroxyapatite and tricalcium phosphate, naturally occurring polymers, such as collagen or gelatine as well as biodegradable material (supra). Further, nanostructured and/or nanpatterned biodegradable matter, including one or more nanofilms, may be used as a scaffold or to structure and/or support the tissue construct being formed or perfused in the apparatus or system of the present invention. An introduction into the options presently available for the use of nanotechnology in vascular tissue engineering has been given by Mironov et al. (Trends in Biotechnology (2008) 6, 338-344).

The tissue construct may be suitable for use as a graft, including e.g. skin, connective tissue, neural tissue, a body structure or a graft of a certain organ or a certain portion of an organ. Any desired cell(s) may be used to engineer such a tissue. Examples include, but are not limited to, pluripotent and multipotent cells such as progenitor cells and stem cells, e.g. adult or embryonic stem cells, cells of a cell line or partly or fully differentiated somatic cells, any of which may also be genetically modified. Tissue engineering aims at generating functional 3-dimensional tissues outside of the body that can be tailored in size, shape and function according to the respective needs before implanting them into the body. Thereby this technique may allow for complete replacement of diseased tissue or reconstitution of missing tissue portions. Size and function of a tissue under construction as well as in vivo survival depend crucially on metabolic supply. The skilled artisan will thus appreciate that the tissue system of the invention, which facilitates delivery of nutrients or removal of metabolites, and which can assist intracellular communication by providing a continuous flow, is particularly suitable for maintaining survival and growth of cells in tissue engineering. This allows for the formation of larger tissue-like structures than conventional technologies, such as static growth.

The formation of many tissues such as e.g. muscle requires an intrinsic vascularization, which needs the supply with a fluid flow. In this regard perfusion with micro-needles and in particular micro-needles with lateral apertures is well suited to fulfil such a requirement. Thereby the tissue system of the invention also supports angiogenesis, i.e. the sprouting of new capillaries from pre-existing vasculature. As angiogenesis is a complex multistep process involving extensive interplay between cells, soluble factors, and components of the extracellular matrix, the skilled artisan will appreciate that the tissue system of the invention, allowing fluid flow in a controllable manner, provides a basic requirement for its occurance. Nevertheless, therapeutic agents modulating angiogenesis such as angiogenic growth factors, peptides and proteins may be used for engineering a tissue using a tissue system of the present invention. Examples of angiogenic growth factors include, but are not limited to, vascular endothelial growth factor (VEGF), fibroblast growth factor-1 (FGF-1), and fibroblast growth factor-2 (FGF-2); illustrative examples of angiogenic inhibitors are platelet factor 4, interferons, and thrombospondin.

Many tissue engineered constructs undergo series of genetic and phenotypic changes during culture. These dynamic processes, particularly in constructs based on three-dimensional scaffolds are not clearly understood due to the limitation of available tools. The tissue system of the present invention allows the tissue engineered construct to be concurrently cultured and the cellular dynamics and cell interaction with its surrounding (neighbouring cells, biomaterial surface and hemodynamic environment) to be visualised. The current system can also be integrated onto organotypic tissue slices culture such as a liver slice. Various stimulations can be artificially introduced to facilitate the study of processes such as pathogenesis of diseases, angiogenesis and tumorigenesis. The method of the present invention can be used as a research tool for in depth understanding of biological processes.

Furthermore, the current invention can facilitate the control of the growth of tissue constructs. By precise control of the growth, this invention can improve the interfacing and integration between the tissue constructs and recipient, e.g. a patient. Integration of engineered tissue constructs into the human and animal body has been a challenge in the field of regenerative medicine. Those skilled in the art will therefore appreciate the potential of the method of the invention in clinical applications.

The fluid used may be any fluid and will generally be selected according the specific requirements of the tissue to which the method is applied. As two illustrative examples, the fluid may be an oxygenated fluid and/or a nutrient-containing fluid. The fluid may for instance include a predetermined amount of a gas such as oxygen, nitrogen or carbon dioxide, of a microorganism, of a virus, of a prion, of an ion or of a compound, such as a peptide, a protein, a nucleotide, an oligonucleotide, a nucleic acid, a lipid, a saccharide, a vitamin, an ion, or a low molecular organic or inorganic compound. The fluid may for instance include a predetermined amount of a factor selected from the group consisting of a growth factor, a differentiation factor, a metabolite, a hormone, a drug, a drug candidate, a prodrug, a vitamin, and an antibiotic. The fluid may also be of a predetermined property such as a selected oxygen tension, carbon dioxide content, a selected temperature or a selected shear flow.

The method of the invention may for example be a method of culturing a tissue, a method of analysing a function of a tissue, a method of growing a tissue or a method of forming a tissue. In some embodiments the method is a method of analyzing an effect of matter such as a microorganism, a virus, a prion, an ion, a lipid, a saccharide, a nucleotide, an oligonucleotide, a nucleic acid, a peptide, a vitamin, a hormone, a synthetic compound or any other factor, including a property (e.g. an oxygen tension, a temperature, and a shear flow) on a tissue contained by a chamber. In such embodiments wherein fluid that is injected into a portion of the tissue typically includes such matter or has such a property. An illustrative example of the effect of matter that may be analyzed in the method of the invention is adsorption of a factor such as an ion, a compound, a gas, a protein or an analyte by at least one cell of the tissue. A further example of the effect of matter that may be analyzed in the method of the invention is the distribution of such matter, e.g. a factor or an analyte, in at least one cell of the tissue. Further examples of the effect of respective matter that may be analyzed in the method of the invention include, but are not limited to, metabolism of matter by at least one cell of the tissue, permeability of the matter to a cell membrane of at least one cell of the tissue, elimination or secretion of the matter by at least one cell of the tissue; and toxicity of the matter on at least one cell of the tissue. Analysing the effect of a factor on the tissue may also include monitoring a selected marker, such as a diagnostic or prognostic marker—typically the expression of a characteristic protein or the occurrence of a nucleic acid or the number of copies thereof. Methods of detecting proteins and nucleic acids are well known to those skilled in the art and include for instance fluorescent in situ hybridization or chromogenic in situ hybridization of nucleic acids or the application of antibodies directed against a protein of interest.

Culturing the tissue may include co-culturing the tissue with a further cell such as a feeder cell, with a stem cell or progenitor cell. In some embodiments the method may include providing a differentiation signal to promote differentiation of a respective stem cell or progenitor cell. In some embodiments the method may include providing a differentiation signal to promote differentiation of the tissue. As an example, the method may include adding a differentiation signal to the fluid or adding matter such as a compound, a nucleic acid or a protein that induces the tissue to generate a respective differentiation signal.

The method typically further includes assaying to determine the effect of such matter. The respective technique used for assaying will be selected according to the property or matter, the effect of which is to be analyzed, and according to the predicted or assumed dimension of the respective effect. Assaying may for instance include microscopic analysis of the tissue, bio-imaging, performing confocal microscopy, performing multi-photon microscopy, histochemically staining the tissue, determining secretion of a biomolecule, determining metabolism of a biomolecule, determining an expression of a protein, determining an activation of a protein, determining an oxygen tension, determining a temperature, determining a shear flow or determining an intracellular level of a metabolite. Microscopic analysis may for example include determining the presence of signs selected from the group consisting of cellular stress, factor toxicity, cellular viability, and cellular death. Examples of a metabolite the intracellular level of which may be determined include, but are not limited to, urea, a monosaccharide such as glucose, dihydroxyacetone, glycerol 3-phosphate, phosphoethanolamine, a phosphatidylcholine, a phospholipid, a fatty acid including e.g. an amino acid, fumaric acid, malic acid, α-ketoglutaric acid, isocitric acid or a bile acid (e.g., cholic acid, chenodeoxycholic acid, taurocholic acid, glycocholic acid or deoxycholic acid), allantoin, or a drug metabolite such as a sulfate, a glucoronide conjugate or N-acetyl-p-benzoquinone imine. Three illustrative examples of a protein the expression of which may be determined are liver albumin, beta galactosidase, and cytochrome P450.

In some embodiments the method of the invention includes transfecting the tissue with one or more nucleic acids or infecting the tissue with one or more viruses or microbes. Examples of such microbes (or microorganisms) include, but are not limited to, a bacteria, algae, a fungus, and a yeast.

The term “nucleic acid” as used herein refers to any nucleic acid molecule in any possible configuration, such as single stranded, double stranded or a combination thereof. Nucleic acids include for instance DNA molecules, RNA molecules, analogues of the DNA or RNA generated using nucleotide analogues or using nucleic acid chemistry, locked nucleic acid molecules (LNA), protein nucleic acids molecules (PNA) and tecto-RNA molecules (e.g. Liu, B., et al., J. Am. Chem. Soc. (2004) 126, 4076-4077). A PNA molecule is a nucleic acid molecule in which the backbone is a pseudopeptide rather than a sugar. Accordingly, PNA generally has a charge neutral backbone, in contrast to for example DNA or RNA. Nevertheless, PNA is capable of hybridising at least complementary and substantially complementary nucleic acid strands, just as e.g. DNA or RNA (to which PNA is considered a structural mimic). An LNA molecule has a modified RNA backbone with a methylene bridge between C4′ and O2′, which locks the furanose ring in a N-type configuration, providing the respective molecule with a higher duplex stability and nuclease resistance. Unlike a PNA molecule an LNA molecule has a charged backbone. DNA or RNA may be of genomic or synthetic origin and may be single or double stranded. Such nucleic acid can be e.g. mRNA, cRNA, synthetic RNA, genomic DNA, cDNA, synthetic DNA, a copolymer of DNA and RNA, oligonucleotides, etc. A respective nucleic acid may furthermore contain non-natural nucleotide analogues and/or be linked to an affinity tag or a label.

Many nucleotide analogues are known and can be used in the method of the invention. A nucleotide analogue is a nucleotide containing a modification at for instance the base, sugar, or phosphate moieties. As an illustrative example, a substitution of 2′-OH residues of siRNA with 2′F, 2′O—Me or 2′H residues is known to improve the in vivo stability of the respective RNA. Modifications at the base moiety include natural and synthetic modifications of A, C, G, and T/U, different purine or pyrimidine bases, such as uracil-5-yl, hypoxanthin-9-yl, and 2-aminoadenin-9-yl, as well as non-purine or non-pyrimidine nucleotide bases. Other nucleotide analogues serve as universal bases. Universal bases include 3-nitropyrrole and 5-nitroindole. Universal bases are able to form a base pair with any other base. Base modifications often can be combined with for example a sugar modification, such as for instance 2′-O-methoxyethyl, e.g. to achieve unique properties such as increased duplex stability. Examples of nucleic acids with which the tissue may be transfected include, but are not limited to, an RNA molecule, including an si RNA molecule, an antisense nucleotide and a nucleic acid encoding a protein such as albumin, beta galactosidase, cytochrome P450, glutathione-S-transferase, sulfotransferase, and N-acetyltransferase.

In embodiments where fluid is recirculated the recirculating may include receiving a tissue-exiting fluid about an outlet port fluidly coupled to the chamber. In some embodiments the method includes embedding the tissue between a flexible device such as a membrane and a member, such as a cover slip. A respective membrane may for instance polydimethylsiloxane (PDMS) membrane. The method may further include encapsulating the tissue in a flexible device such as a membrane, and/or partially embedding the tissue in a flexible device such as a membrane (e.g. a polydimethylsiloxane (PDMS) membrane).

The present invention also provides a kit. The kit includes one or more tissues configured for use in a tissue system as defined above. The kit may further include a chamber for containing the tissue. In some embodiments the one or more tissues are contained by the one or more chambers configured for use in the tissue system. Further, the kit may include a device such as a valve, or it may include a chamber top cover with an aperture or a valve that is capable of serving as an inlet port. The kit may also include a device such as a valve, or it may include a chamber with an aperture or a valve that is capable of serving as an outlet port. Further, the kit may include one or more micro-needles as described above. The kit may also include means for assembling a tissue system as described above.

The headings (such as “Background of the Invention” and “Summary of the Invention”) used herein are intended only for general organization of topics within the disclosure of the invention and are not intended to limit the disclosure of the invention or any aspect thereof. In particular, subject matter disclosed in the “Background of the Invention” may include aspects of technology within the scope of the invention and may not constitute a recitation of prior art. Subject matter disclosed in the “Summary of the Invention” is not an exhaustive or complete disclosure of the entire scope of the invention or any embodiments thereof.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make, use and practice the compositions and methods of this invention and, unless explicitly stated otherwise, are not intended to be a representation that given embodiments of this invention have, or have not, been made or tested.

### EXAMPLES

The following examples are intended to be illustrative and are not intended to limit the scope of the invention.

### Example 1

### Perfusion Using a Micron-Sized Needle

### Perfusion Studies using Trypan Blue

Long-term tissue culture of thick tissue slices has always been the holy grail of tissue slice tissue engineering. Thick tissue slices has been shown to possess better morphology and functionality (Shigematsu et al, Experimental and Molecular Pathology (2000) 69: 119-143), however, the culture duration is limited due to mass transfer limitations. Utilization of dynamic cultures enhances mass transfer, but exposes the tissue to mechanical abrasions and damage. Embedding tissue slices in agarose has been shown to protect the tissue and hence, improve viability and functionality to the extent of prolonging the survival of the tissue (Nonaka et al, Cell Transplantation (2003) 12: 491-498). The current example illustrates how a single micron-sized needle can be used to perfuse a thick liver slice under static and embedded conditions.

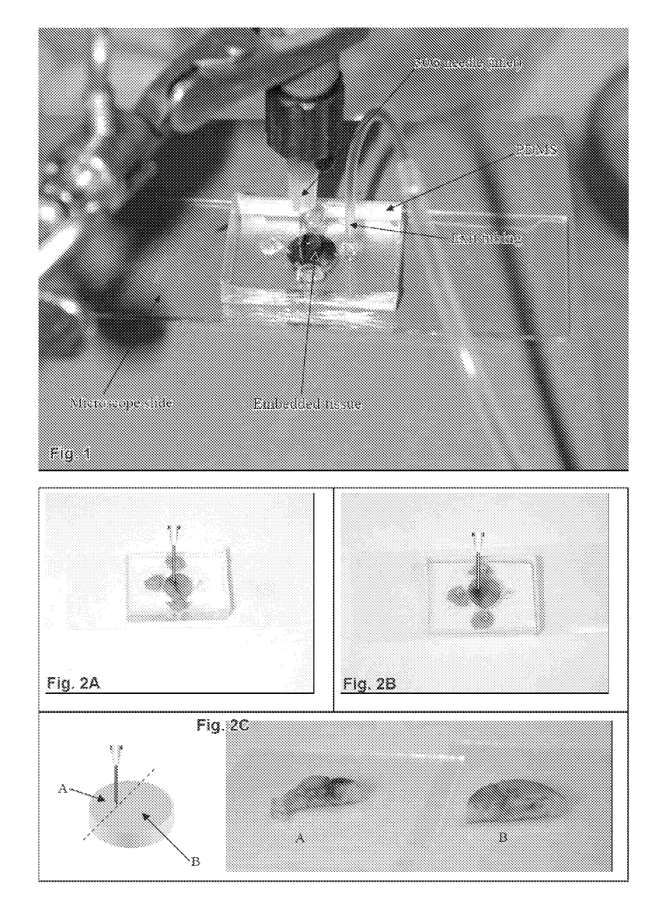

Livers perfused with 4% formalin at 37° C. were excavated from Male Wistar rats (weight of approximately 250 g) that were anaesthetized using sodium phenobarbitone and injected with 0.5 mL heparin. Tissue cylinders from liver samples were prepared using an 8-mm diameter coring tool on a motor-driven tissue coring device. Tissue slices were precision-cut to 2 mm using a vibratome (DTK-1000, Pelco International, Redding, USA). 10% Trypan Blue dye was perfused into the 2 mm thick tissue slice using a set-up as shown in FIG. 1.

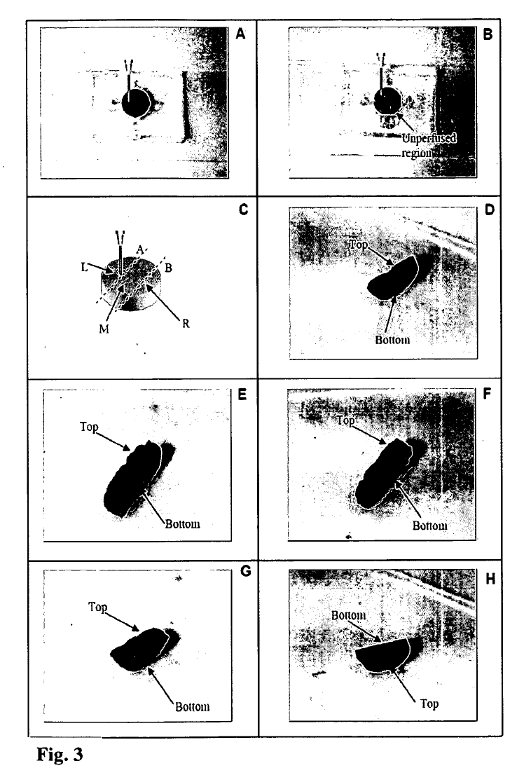

FIG. 2 shows the 2 mm thick tissue slice that has been perfused with Trypan Blue for 5 minutes. As shown in FIG. 2(c) the dye has penetrated the entire cross section of the tissue particularly at the needle puncture point. Using a similar configuration, when the perfusion was conducted for 1 hour, the entire tissue was stained with Trypan Blue (FIG. 3). Since using a single needle exhibit enhanced mass transport efficiency, utilization of an array of micro-needles can achieve higher efficiency and eliminate the unperfused regions.

### Example 2

### Perfusion Using a Micron-Sized Needle

Perfusion studies using Rho 6G and correlation to liver slice viability. Enhanced mass transfer of nutrients and removal of wastes is often correlated to improved viability and functionality of living cells and tissues. Example 1 illustrates how a single micro-needle can be used to interface with existing microvasculature and hence, perfuse through the sinusoidal pathways. The current example aims to illustrate the correlation between improved perfusion and mass transfer to the viability of liver slice.

Livers perfused with UW solution at 4° C. were excavated from Male Wistar rats (weight of approximately 250 g) that were anaesthetized using sodium (Alabama Research and Development, Germany) (Krumdieck et al, 1980) or 2 mm using a vibratome (DTK-1000, Pelco International, Redding, USA). 2 ml of 100 μM Rho 6G dye was perfused into the 2 mm thick tissue slice using the set-up as shown in FIG. 1. Diffusional studies were performed by incubating 300 μm and 2 mm slices in 3 ml of 100 μM Rho 6G under static and rocking conditions. Stained slices were imaged under confocal microscopy (Zeiss LSM 510) using 10× objective at excitation wavelengths and emissions wavelengths of 543 nm and 565 nm respectively. For each tissue slice, a stack of 76 optical sections was captured at every 2 μm increment (total thickness of each stack is 150 μm).

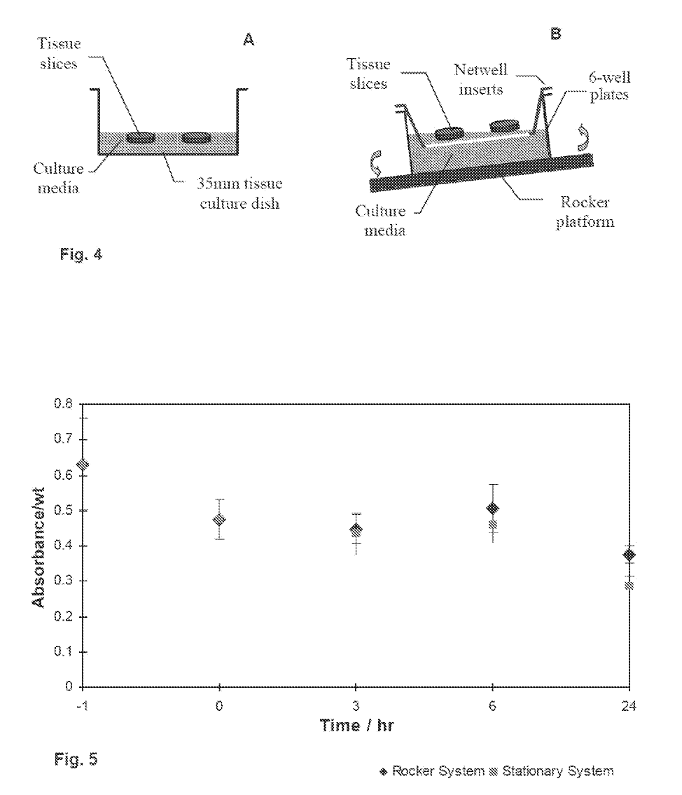

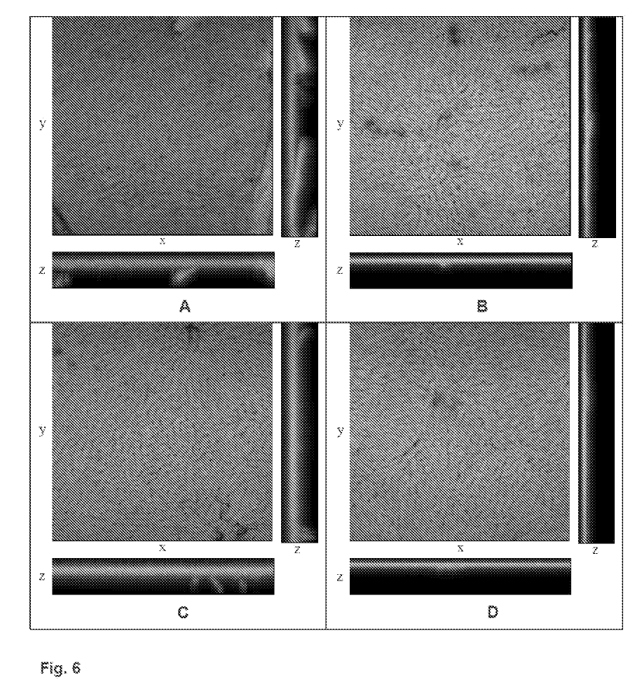

In FIG. 5, it can be observed that incubation under rocking conditions improved the survival of the tissue, particularly after a 24 hr culture. The improved viability can be correlated to the diffusion of the nutrients into the tissue, as illustrated by analogous diffusion investigations using Rho 6G in FIG. 6. This figure demonstrates the penetration of the dye after 1 hour incubation into the tissue for both static and rocking conditions. Under static conditions, the dye seems to accumulate at a short distance from the surface of the tissue, hence giving a thin highly fluorescent layer. In comparison to the rocker system, the dye penetration is more diffused, resulting in a lower intensity but thicker fluorescent layer.

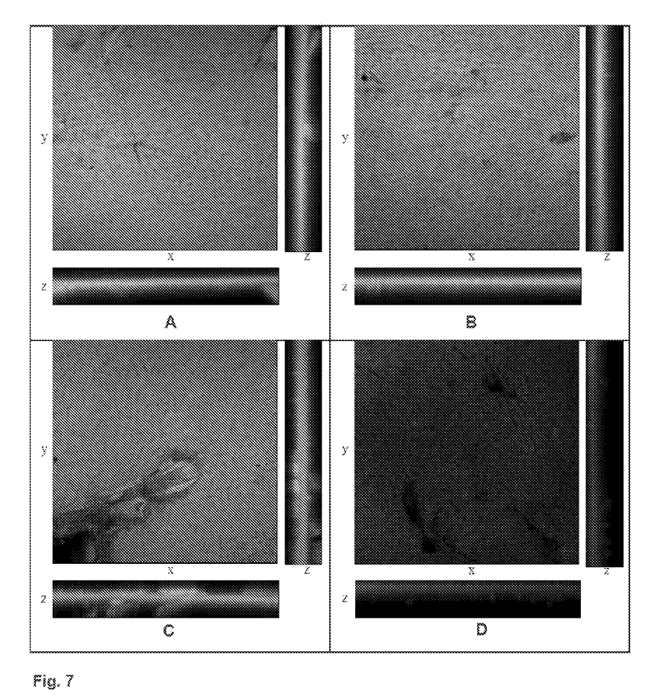

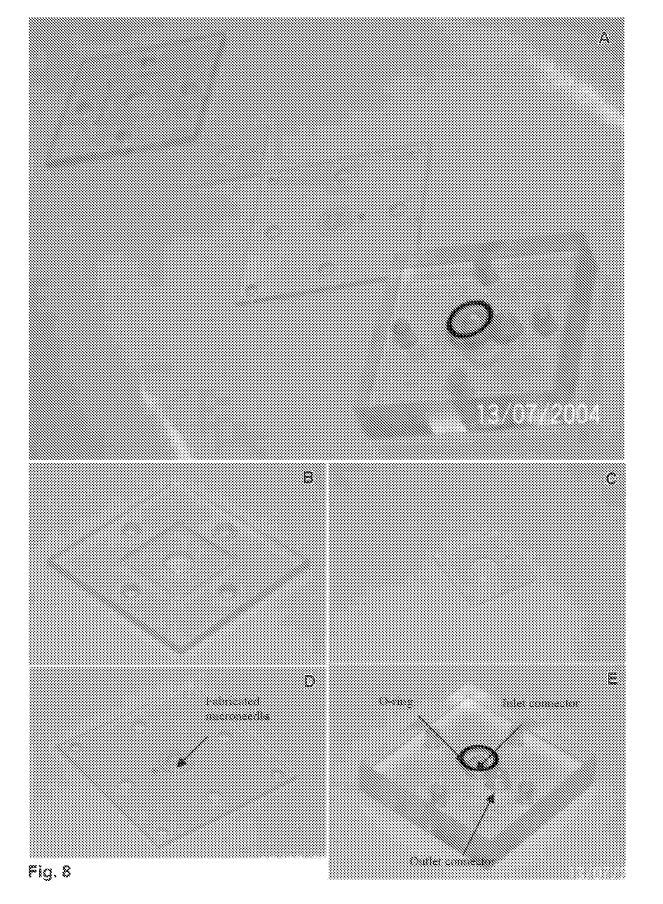

Using this correlation, a similar diffusional investigation using a 2 mm thick liver slice and under needle perfusion was conducted (as illustrated in FIG. 7). Results indicate that using a micro-needle perfusion enables the dye to penetrate to at least a depth comparable to the rocker system. This is illustrated by the thick diffuse fluorescent layer on both the top and bottom layer of the tissue. The needle perfusion also possesses a significant advantage to perfuse thick tissue sections in comparison to the rocker system. As shown in FIGS. 7(c) and (d), the top layer of the needle perfused tissue is uniformly stained, however, the rocker incubated tissue is very faintly stained.

The above studies establish that a single micron-sized needle can be used to interface with the existing microvasculature of the tissue slice and thus, enable efficient perfusion for nutrients delivery and waste removal. This efficiency can be further enhanced with the integration of an array of micro-needles. Moreover, micro-needle perfusion provides a platform to eliminate mass transfer limitations for thick tissue sections, consequently, improving the survival of thick tissue sections over a long-term culture.

Embedding tissues in a PDMS chamber can be an option that can, for example, protect the surface of the tissues from mechanical abrasion and damage, hence, reducing apoptotic signals from the surface that can result in degenerative tissues.

### Example 3

### Perfusion Using a Micron-Sized Needle and a Micro-Needle Chamber

Examples 1 and examples 2 show perfusion of a liver slice using a single micro-needle. The current example illustrates the perfusion of the liver slice using a fabricated micro-needle chamber.

### Methodology

Fabrication of micro-needle chamber. The micro-needle chamber comprises of 4 parts (FIG. 8):
Part 1—base: This part is designed to hold a 22 mm×22 mm coverslip and the PDMS membrane.
Part 2—PDMS Membrane: This membrane is designed to hold the 8 mm tissue slice.
Part 3—Micro-Needle Platform: A micro-needle array comprising of 4 needles is CNC fabricated into this platform.
Part 4—Top Cover: The top cover is designed to enclose the chamber and for connections to the perfusion circuit.

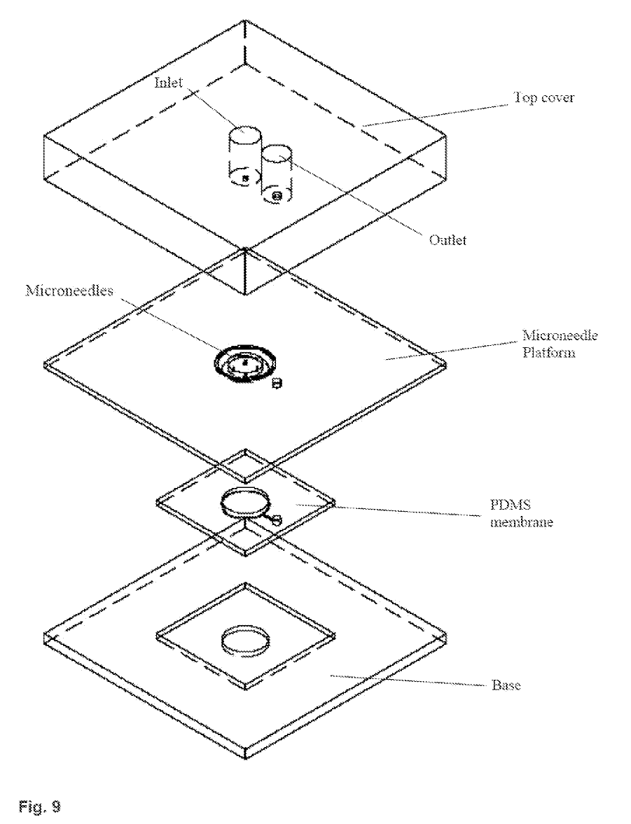

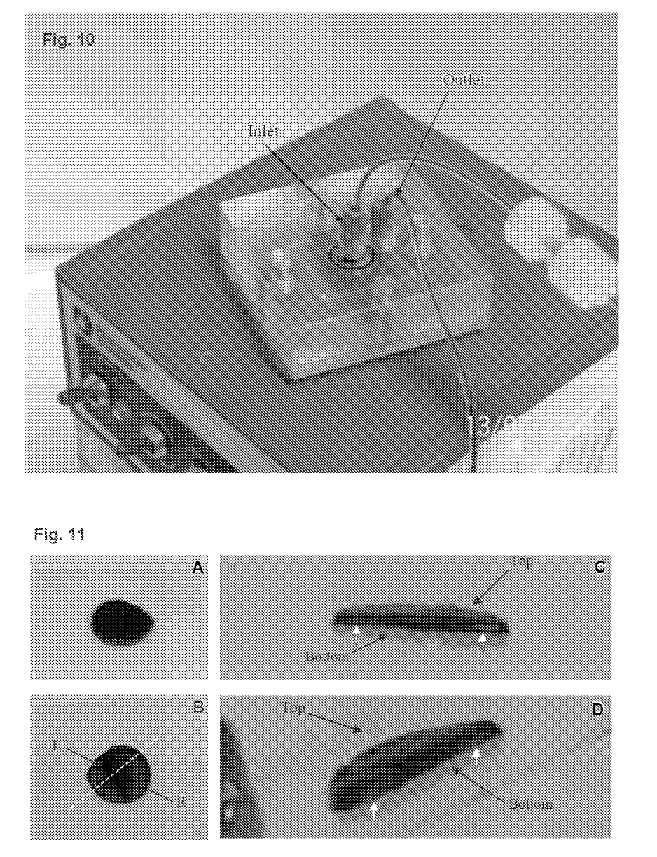

A schematic representation of the micro-needle chamber and its assembly is as shown in FIG. 9. The chamber is fixed together using M4 screws and connected to the perfusion circuit as shown in FIG. 10. Fluid is pumped from a reservoir by a peristaltic pump (P-1, Amersham) to enter the chamber via a center inlet, exits via a side outlet and is returned to the reservoir.

### Diffusional Studies

Liver slices are prepared by excavating UW solution perfused liver from Wistar rats (250-300 g) and sliced to 900 μm using the Krumdieck slicer (Alabama Research and Development, Germany). 3 ml of 100 μM Rhodamine 6G dye or 10% Trypan Blue was perfused into the 900 μm thick tissue slice for 1 hour using the set-up as described above. A static control was set up by incubated a 900 μm tissue slice in 3 ml of Rhodamine 6G. Rhodamine 6G stained slices were imaged under confocal microscopy (Zeiss LSM 510) using 10× objective at excitation wavelengths and emissions wavelengths of 543 nm and 565 nm respectively. For each tissue slice, a stack of 76 optical sections was captured at every 2 μm increment (total thickness of each stack is 150 μm).

FIG. 11 shows the diffusional results of a 900 μm liver slice perfused with 10% Trypan Blue using the micro-needle chamber. As shown in FIG. 11a, the top of the tissue is entirely perfused, whereas the bottom of the tissue (FIG. 11b) is partially perfused. Cross sections of the tissue (as shown in FIGS. 11c and d) show that the dye has penetrated into deeper layers of the tissue (note: several regions remain to be perfused as indicated by the small arrows in the figure).

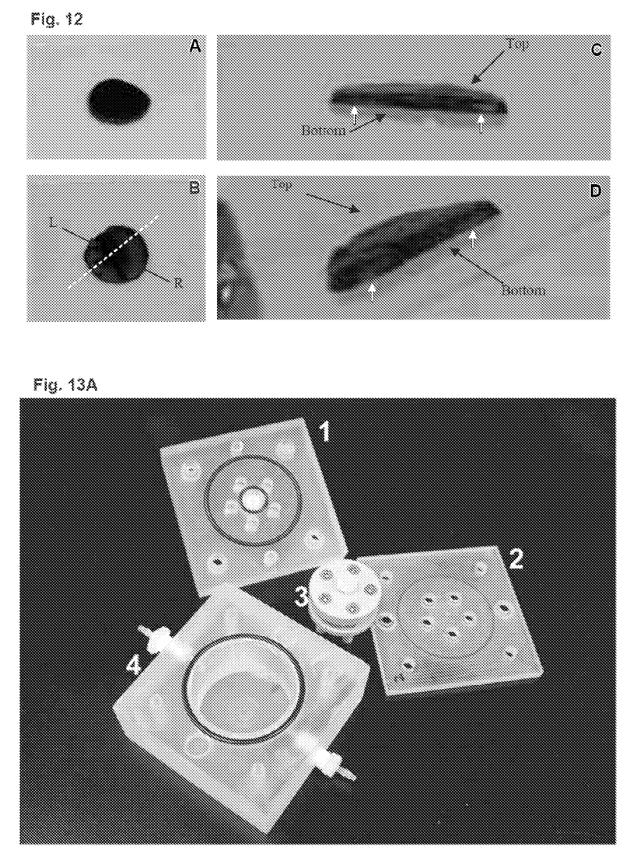

Rhodamine 6G diffusional studies of the perfusion system and the static culture results are shown in FIG. 12. Diffusion into the tissue slice using the micro-needle perfusion system demonstrates that the dye has penetrated into the liver slice. In comparison to the static culture, dye penetration in the micro-needle perfusion system is observed to be more diffused and penetrated deeper than the static system.

This example shows the possibility of utilizing a micro-needle array fabricated into a micro-needle chamber to perfuse a thick tissue slice. Diffusional studies show that the penetration of dye is improved in comparison to a static system, thus, demonstrating improvement in mass transfer.

### Example 4

### Perfusion Using a Plurality of Micron-Sized Needles

### Materials

All chemicals and reagents were purchased from Sigma, Singapore, unless otherwise stated.

Male Wistar rats (weighed approximately 250-300 g) were anesthetized using pentobarbitone sodium (0.1 mL/100 g, Nembutal®, Abbott Laboratories, Parramatta, NSW, Australia) and injected with 0.5 mL heparin (Leo Pharmaceuticals, Ballerup, Denmark). Livers were perfused with University of Wisconsin (UW) solution at 4° C. (Viaspan, Bristol-Myers-Squibb, Princeton, N.J.) for live culture or 3.7% paraformaldehyde at 37° C. for 1 h followed by 1 μM fluorescein for 30 min to obtain fixed samples, and excised. Tissue cylinders from liver samples were prepared using an 8-mm-diameter coring tool on a motor-driven tissue coring device (Alabama Research and Development, Bad Homburg, Germany). Liver slices were precisely cut to the desired thickness of 300 mm or 1 mm using a Krumdieck slicer (Krumdieck, C. L., et al., Anal. Biochem. (1980) 104, 118) (Alabama Research and Development) in UW solution.

### Perfusion Chamber Design and Perfusion System Setup

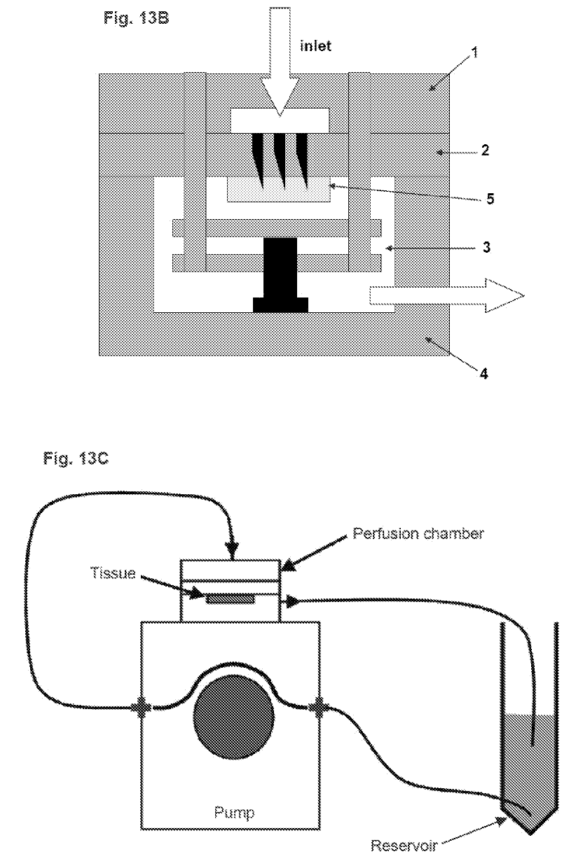

A schematic diagram of the experimental setup is shown in FIG. 13. A multineedle perfusion chamber was designed to conduct ITP culture (FIG. 13A, FIG. 13B). This ITP perfusion bioreactor included 4 parts, namely: (a) Part 1—top cover (polycarbonate): The top cover encloses the chamber and inlet connections, and holds the needle fluid chamber; (b) Part 2—needle platform (polycarbonate): The platform incorporates an array of 7 stainless steel needles. The array of needles is arranged in a hexagonal pattern at a distance of 2.5 mm. (c) Part 3—Adjustable brace (PEEK): This brace holds the cells-seeded scaffolds in place, and includes 5 supporting struts with a fixed plate and a pressure plate. A Teflon screw is used to control the position of the pressure plate, hence, allowing culture of tissue constructs with different thicknesses. Micro-holes of 500 μm were drilled on the pressure plate to allow fluid flow from the top to the bottom of the tissue constructs; (d) Part 4—Bottom chamber (polycarbonate): The lower chamber encloses the chamber and outlet connections, and holds the tissue constructs and adjustable brace.

The perfusion chamber was connected to a closed-loop perfusion setup as illustrated in FIG. 13C. A multichannel peristaltic pump (IPC-N-12, Ismatec, Glattbrugg, Switzerland) was used to drive the fluid flow. The system was connected via Tygon® dual-stop pump tubing (1.02 mm ID, Glattbrugg, Switzerland) and Silastic® laboratory tubing (1.02 mm ID, Dow Corning, Midland, Mich.). The peristaltic pump drew fluid from a reservoir and pumped the fluid into the liver slice via the micron-sized needles immobilized in the needle platform as described above. Fluid was collected in the bottom chamber and diverted back to the reservoir. The flow rate was controlled via a digital controller on the pump.

### Propidium Iodide Diffusion Studies

One-millimeter-thick liver slices preperfused with fluorescein were perfused with 25 μg/mL propidium iodide (PI) in 1× phosphate-buffered saline (PBS) at room temperature for 1 h using the seven-needle ITP system, and incubated statically. The perfused surfaces of the liver slices were then imaged using a stereomicroscope (Olympus SZX12, Olympus, Tokyo, Japan). Perfused liver slices were sectioned at cross-sections X and Y (FIG. 13D), and subsequently immo-bilized in optimal cutting temperature medium (Jung Tissue Freezing Medium, Leica Microsystems, Nussloch, Germany). Liver slice cross-sections were cryo sectioned to 20 μm using a cryostat (Leica CM3050S, Leica Microsystems, Wetzlar, Germany). Cross-sectional thin slices were immobilized on microscope slides coated with Fro-Marker (Electron Microscopy Science, Hatfield, Pa.) and visualized under a confocal microscope (LSM 510, Carl Zeiss, Heidenberg, Germany) using a 10× objective and a tile scan function (Fluorescein excitation: 488 nm, emission: 500-550 nm; PI excitation: 543 nm, emission: 565-615 nm).

### Liver Slice Culture

Liver slices were prepared as described above and cultured in Hepatozyme-SFM (GIBCO Laboratories, Chagrin Falls, Ohio) supplemented with 100 U/mL penicillin, 100 mg/mL streptomycin, and 0.1 μM dexamethasone for up to 3 days using the static culture and the seven-needle ITP culture systems. Prior to culturing, liver slices were preincubated in culture media for 1 h to allow liver slices recovery and removal of cellular debris. In the static culture, liver slices were floated in a 12-well plate and cultured using 1.5 mL of culture media. The ITP system was setup as described above, and 1-mm-thick liver slices were cultured using 14 mL of culture media. The flow rate was increased from 0.1 to 1.0 mL/min at an increment of 0.1 mL/min every 2 min to reduce damage to liver slices associated with a sudden pressure change. All cultures were incubated at 37° C. and 95% air, 5% carbon dioxide (CO₂) with daily change of culture media; samples were removed from culture on day 1 and day 3 for cell viability and functionality assays.

### Histology

Liver slices obtained from culture were fixed in 10% buffered formalin and stored at 4° C. prior to processing. The liver slices were then embedded in paraffin overnight after drying in sequential ethyl alcohol concentrations (70%, 90%, and 100%) using a tissue-processing instrument (Sakura Tissue Tek VIP, Sakura Finetek Europe B.V., Zoeterwoude, The Netherlands). The paraffin blocks containing liver slices were cut into 5 mm sections using a microtome (Leica RM2235, Leica Microsystems) and mounted onto a poly-lysine-coated microscope slide. The samples were subsequently deparaffinized, rehydrated, and stained with hematoxylin and eosin (H&E) dyes.

### Cell Viability Assays

Cell viability of liver slices was evaluated using a live/dead assay, which comprises C₁₂-resazurin (Vybrant® Cell Metabolic Assay Kit, Molecular Probes, Eugene, Oreg.) for detection of live cells (excitation/emission wavelength=543 nm/565-615 nm), and SYTOX Green (Molecular Probes) for detection of dead cells (excitation/emission wavelength=488 nm/500-530 nm). Liver slices were incubated or perfused with 500 nM of SYTOX Green and 5 mM of C₁₂-resazurin for 30 min at 37° C. and 95% air, 5% CO₂. The liver slices were rinsed with 1×PBS, fixed in 3.7% paraformaldehyde, and mounted onto cover slips to be imaged using confocal microscopy (LSM 510, Carl Zeiss). For each liver slice, an image was acquired at 2 μm z-increments to obtain z-stack images of the liver slice. AlamarBlue assay was conducted to obtain a quantitative evaluation of the cell viability. Liver slices were incubated under static condition and perfused using ITP for 2 h at 37° C. and 95% air, 5% CO₂ with 10% AlamarBlue (Biosource, Camarillo, Calif.). The medium was collected and fluorescence was measured at an excitation and emission wavelengths of 560 and 590 nm, respectively. The results were normalized to total protein of the tissue, which was evaluated using the Bradford method (Vickers, A. E. M., et al., Toxicol. Sci. (2004) 82, 534).

### Phase I and Phase II Metabolic Activity Assays

Phase I metabolic activities of liver slices were evaluated by incubating the liver slices in 39.2 μM 7-ethoxyresorufin for 4 h at 37° C. and 95% air, 5% CO₂ under static and ITP conditions (Toh, Y. C., et al., Assay Drug Dev. Technol. (2005) 3, 169; Chia, S. M., et al., Tissue Eng. (2000) 6, 481) The liver slices were rinsed with 1×PBS and fixed in 3.7% paraformaldehyde. The liver slices were mounted in 10 mL of fluorescent mounting medium (DakoCytomation, Carpinteria, Calif.) on cover slips to be imaged using confocal microscopy (LSM 510) with excitation and emission wavelengths at 543 nm and 565-615 nm, respectively. For each liver slice, a 2-μm-thick optical image was acquired at 2 μm increments to obtain z-stack images of the liver slice. A maximal projection of the z-stack images was obtained.

To evaluate the uridine diphosphate-glucuronyl transferase (UGT) activity indicative of phase IImetabolic activities, liver slices were incubated under static condition and perfused using ITP for 2 h at 37° C. and 95% air, 5% CO₂ with 100 μM 4-methylum-belliferone (4-MU). The media were collected, and the production of 4-methylumbelliferone glucuronide (4-MUG) was determined using fluorescent capillary electrophoresis on a PrinCE System (Prince Technologies B.V., Emmen, The Netherlands) equipped with a ZETALIF 2000 laser-induced fluorescence detector (Picometrics S.A., Toulouse, France). Separation was performed with 100 mM sodium acetate buffers (pH 6.5) at 17 kV and 50 mbar for 30 s in a fused-silica capillary (75 mm ID×360 mm OD×70 cm length, Picometrics S.A.) at an excitation wavelength of 325 nm and a 350 nm cut-off emission filter. The results were normalized to total protein of the tissue as described above.

### Albumin Synthetic Function Assay

Culture medium for static and ITP cultures was collected after 1-day and 3-day culture. The albumin concentration was determined using enzyme-linked immunosorbent assay (ELISA) as recommended by the manufacturer (Rat Albumin ELISA Quantification Kit, Bethyl Laboratories, Montgomery, Tex.). The results were normalized to total protein of the tissue as described above.

### Urea Synthetic Function Assay

Liver slices were incubated under static condition and perfused using ITP for 1.5 h with 1 mM ammonium chloride (NH₄Cl) solution at 37° C. and 95% air, 5% CO₂. The medium was collected, and conversion of NH₄Cl to urea was determined via colorimetric detection as recommended by the manufacturer (Urea Nitrogen Direct Diacetyl-monoxime Detection Kit, Stanbio Laboratory, Boerne, Tex.). The results were normalized to total protein of the tissue as described above.

### Statistical Analysis

Data and results are presented as the mean±standard error of means (SEM). Student's t-test was used to evaluate the significant differences between different sets of data.

### Results

### ITP Improves Mass Transfer in Thick Liver Slices

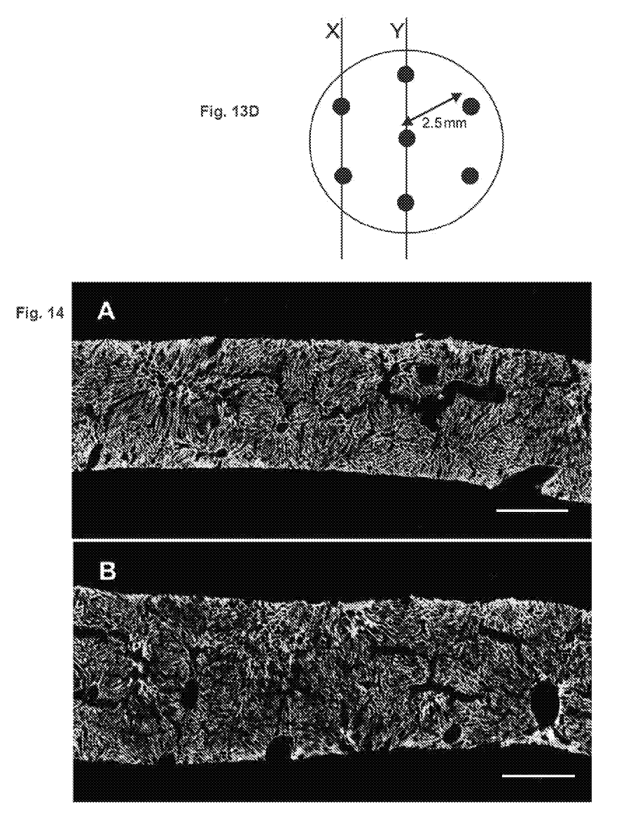

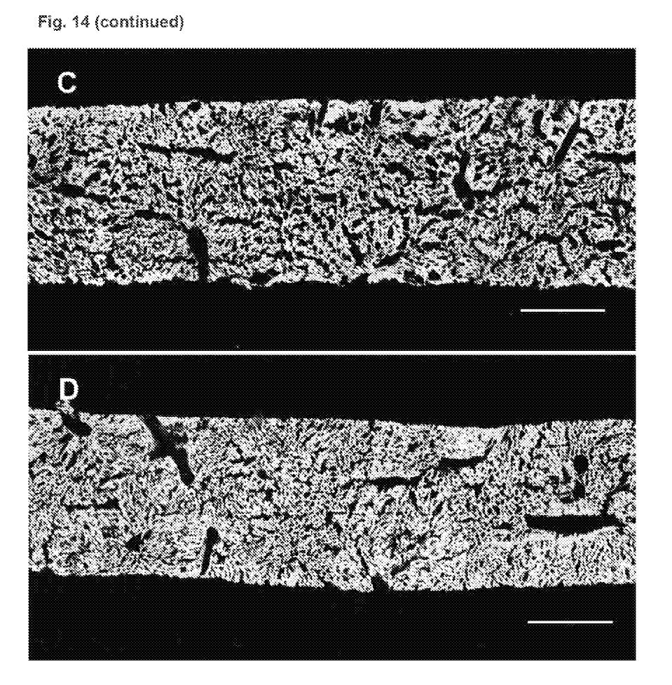

To demonstrate that the ITP system can overcome mass transfer limitations, we evaluated the fluid distribution efficiency in the tissue using the ITP. The efficiency of fluid distribution and uniformity within the thick liver slices are demonstrated by investigating the extent of PI staining throughout the cross-sections of the thick liver slices (FIG. 14). Although the top and bottom surfaces were uniformly stained for both static and ITP systems (results not shown), the cross-sections show that the internal core layers of the liver slices in the ITP system were very well stained compared to the static system in which the dye could not access material beyond the surfaces. Both cross-sections X (2 mm off center) and Y (at the center of the tissue) for the ITP-stained liver slice demonstrated uniform dye staining throughout the tissue, suggesting that the ITP system not only improves media delivery but also enhances uniformity of distribution in the thick liver slices.

### Tissue Structure Characterization by Histology

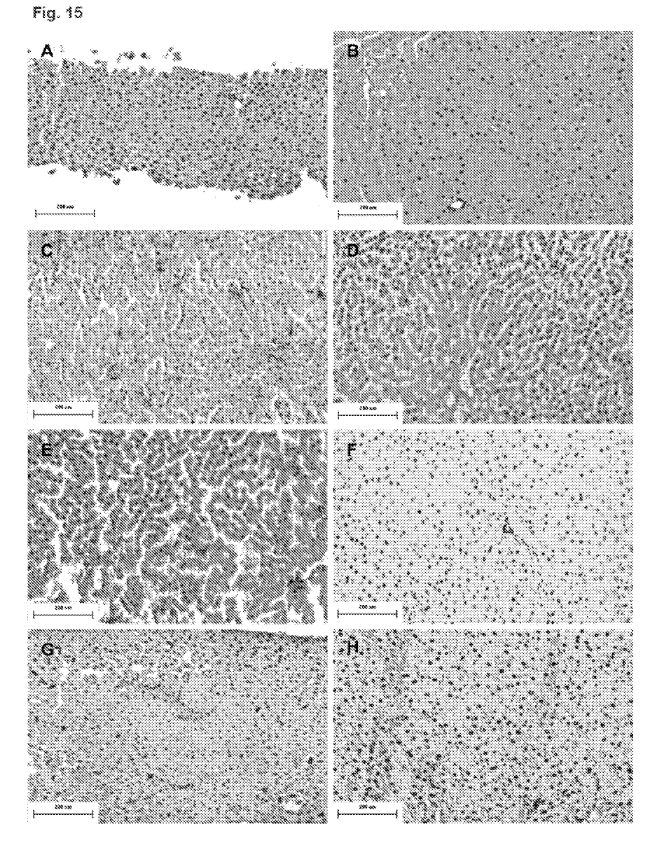

The applicants cultured the liver slices in the ITP system for 3 days and investigated whether the improvement in mass transfer translates into better maintenance of tissue structural integrity and long-term cell viability in the liver slices. They studied the structural changes of the liver slices cultured for 3 days in the static and ITP systems via H&E histological staining (FIG. 15). The cells in freshly isolated liver slices (FIG. 15A, B) were more rounded in shape with a compact arrangement and intact nucleus. After 1-day culture, the static-cultured liver slices showed structural dissociation of the tissue where enlarged interstitial space between the cells was observed (FIG. 15C, E). The 1 mm liver slices under static culture showed the most severe dissociation, and cell death was observed in the inner core layers of the slice. Structural dissociation became more severe on day 3 in the static system (FIG. 15D, F). For the 1 mm liver slices under ITP culture, structural integrity was maintained after one day (FIG. 15G). However, the cells appeared slightly compressed, possibly due to pressure compression induced by flow. After 3-day culture, the liver slices remained viable with mild enlargement of interstitial space, which may be attributed to the enlarged flow paths (FIG. 15H).

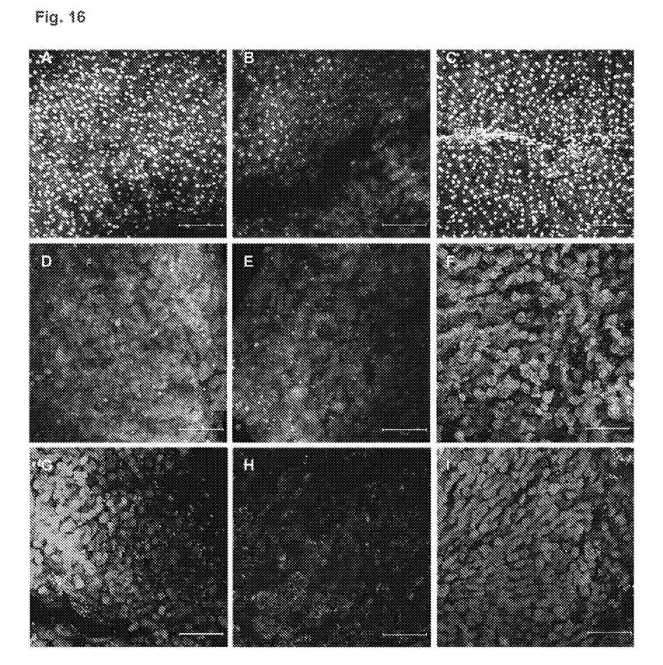

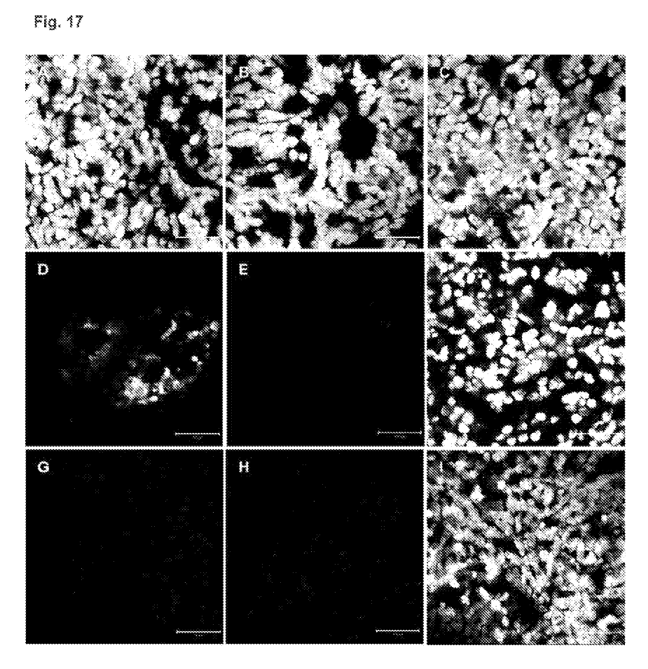

To evaluate the cell viability of the liver slices cultured with the ITP system, we performed a live/dead staining using C₁₂-resazurin (reduced to fluorescent resorufin only in metabolically active live cells) and SYTOX Green (enters cells with compromised membranes, and thus stains the nucleus of dead cells green) (FIG. 16A). More dead cells were observed in liver slices on the day of isolation (day 0) due to surface damage incurred during mechanical slicing. After 1-day culture, the dead cells had been shed off so that the eminent nucleus staining of dead cells was not apparent. The ITP-cultured 1 mm liver slices exhibited higher level of metabolic functions with essentially all cells in the liver slices brightly and uniformly stained with C₁₂-resazurin than those in static-cultured controls, which exhibited weak and diffused signals. After 3-day culture, the ITP-cultured liver slices maintained brightly and uniformly stained C₁₂-resazurin signals while the static-cultured controls further deteriorated.

To further quantify the cell viability of the liver slices, we performed an AlamarBlue assay to evaluate the metabolic activities of the liver slices (FIG. 18A). During the 3-day culture, the 1 mm ITP liver slices were metabolically more active than the static-cultured liver slices. The AlamarBlue reduction activity of the ITP-cultured liver slices was consistently twofold higher than that of the 300 μm staticcultured liver slices and 2.5-fold higher than that of 1 mm static-cultured liver slices. The 300 μm static-cultured liver slices exhibited slightly higher metabolic activities than the 1 mm static-cultured liver slices.

### Phase I and Phase II Metabolic Activities

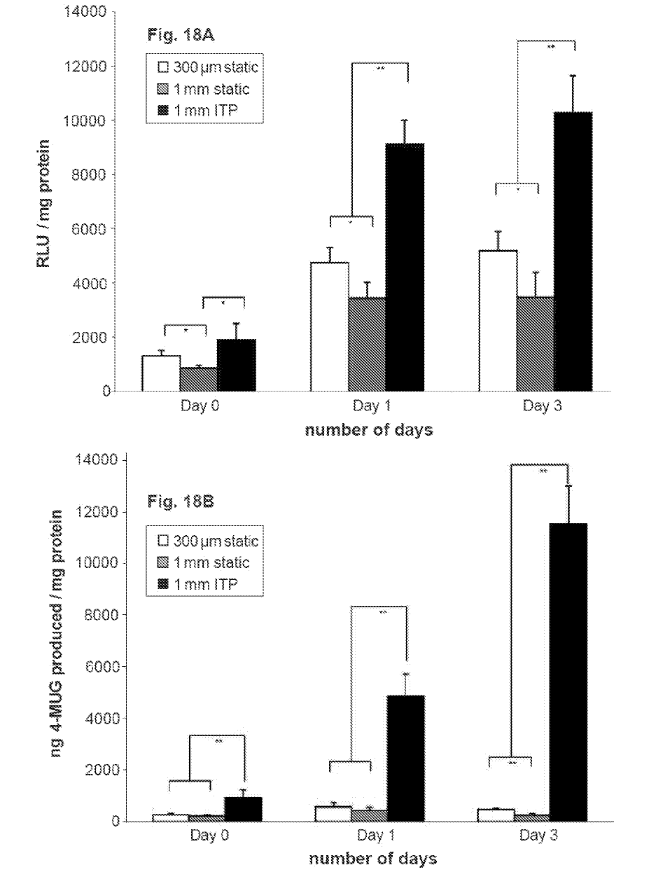

For application as an in vitro tissue culture model for xenobiotic ADME/Tox testing, it is critical that the liver slices should maintain metabolic functions for a minimal period of 3 days as required by the FDA for studying drug-drug interaction (U.S. Department of Health and Human Services, Food and Drug Administration, Center for Drug Evaluation and Research (CDER), Center for Biologics Evaluation and Research (CBER), and Drug Interaction Studies. Study Design, Data Analysis, and Implications for Dosing and Labeling: Preliminary Concept Paper. 2006.). Phase I metabolic activities in the liver slices were investigated by measuring the 7-ethoxyresorufin-Odeethylase (EROD) activity, which is indicative of the activity of the xenobiotic metabolizing cytochrome enzyme, CYP 1A (FIG. 17A-I). On day 0, both static- and ITP-cultured liver slices exhibited high EROD activity (FIG. 17A-C). After 1-day culture, 300 μm static-cultured liver slices showed low EROD activity (FIG. 17D); no EROD activity was detected in 1 mm static-cultured liver slices (FIG. 17E) while the 1 mm ITP-cultured liver slices maintained high EROD activity (FIG. 17F). After 3-day culture, the static cultured liver slices of both 300 μm and 1 mm did not show any EROD activity (FIG. 17G, H) while the EROD activity was maintained in the ITP-cultured liver slices (FIG. 17I).

Phase II metabolic activities in the liver slices were evaluated by measuring the production of 4-MUG, which is indicative of UGT activity (FIG. 18B). The static-cultured liver slices showed a slight decrease in UGT activity from day 1 to day 3. Throughout the 3-day culture, the ITP-cultured liver slices exhibited an increase in UGT activity at the level that is significantly higher than that of the static-cultured controls.

### Albumin and Urea Synthetic Functions

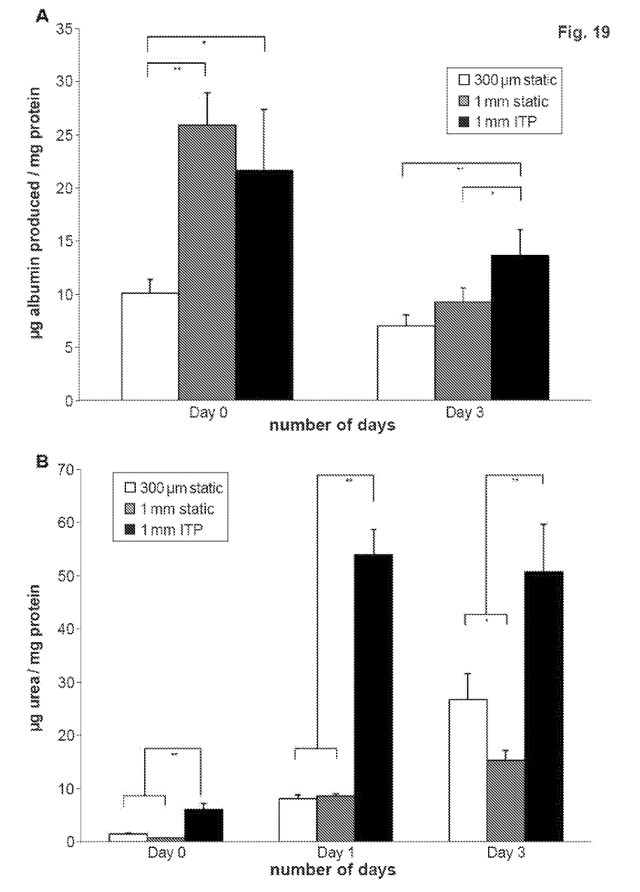

Albumin and urea synthetic function assays were conducted to further characterize the effectiveness of the ITP in maintaining other liver-specific functions of the liver slices (FIG. 19). After 1-day culture, both the 1 mm static and 1 mm ITP-cultured liver slices exhibited significantly higher level of albumin synthetic function than the 300 μm control (FIG. 19A). The amount of albumin detected may be partially contributed by the necrotic cells being shed off during the first day of culture. After 3-day culture, the number of cells shed from the liver slices had dropped to insignificant levels and the 1 mm ITP-cultured liver slices exhibited higher level of albumin synthetic function than the static-cultured controls. Urea produced by the liver slices increased over the 3-day culture period (FIG. 19B). The urea production by the ITP-cultured liver slices was twofold to sixfold higher than that of the static-cultured controls throughout the 3-day culture. Therefore, ITP significantly improves the detoxification functions of thick liver slices.

### Albumin and Urea Synthetic Functions

Maintaining adequate mass transfer in an engineered tissue construct is critical (Martin, Y., & Vermette, P., Biomaterials (2005) 26, 7481). The molecular diffusion distance of nutrients and oxygen is not more than a 100-200 μm from a supplying capillary (Colton, C. K., Cell Transplant. (1995) 4, 415; Vander, A., Sherman, J., & Luciano, D. Human Physiology: The Mechanism of Body Functions, 8th ed. Boston: McGraw-Hill, 2001). Oxygen carriers can somewhat enrich the oxygen content in culture medium to support cells in the interior of large constructs (Sullivan, J., & Palmer, A. F., Biotechnol. Prog. (2006) 22, 1374; Radisic, M., et al., Tissue Eng. (2006) 12, 2077; Gordon, J., et al., Biotechnol. Prog. (2005) 21, 1700). A consistent delivery of nutrients via a continuous perfusion circuit is important to ensure cell survival throughout the entire tissue-engineered construct for optimal structural and functional maintenance. For some tissues, such as liver, that naturally depend on microcirculation in vivo, the engineered internal flow in tissue constructs can reinstate a more controllable hemodynamics to mimic the physiological cellular responses to their surrounding micro-environment (Ingber, D. E., Proc. Natl. Acad. Sci. U.S.A. (2005) 102, 11571; Bilodeau, K., & Mantovani, D., Tissue Eng. (2006) 12, 2367). Consequently, many recent tissue-engineering research efforts have focused on reconstructing microcirculation structures within scaffolds to facilitate uniform media perfusion into the entire scaffold (Laschke, M. W., et al., Tissue Eng. (2006) 12, 2093; Sachlos, E., et al., Tissue Eng. (2006) 12, 2479). Reconstruction of such scaffold constructs in a consistent and reproducible manner has been less than satisfactory.

Instead of reconstructing microcirculation within scaffolds, we have developed a novel ITP system using an array of micron-sized needles as a delivery conduit. The needles are designed to bypass the surface to integrate with the innate internal flow paths that supply media to viable cells in the inner core layers of the tissue construct, and thus enhance distribution of media and removal of metabolic wastes. Such a scheme eases the complexity of the scaffold required for thick tissue culture and provides the versatility of independently controlling the flow rate and pressure of the system.

The applicants have applied the ITP system to the liver slice culture, a classical system in which mass transfer limitation constrains the long-term survival and functions of the liver slice. The micron-sized needles serve as a substitute for the preceding vasculature in vivo that was connected to the liver tissues, and distribute fluid uniformly throughout the liver slice via the innate flow paths within the tissue. The effectiveness of the fluid distribution is evidently demonstrated in the PI staining of the liver slice, and the extent of staining surpasses the diffusional limits achievable via passive diffusion.

Compared to the static culture, the improvement in mass transfer enables the ITP system to maintain liver slices with better structural integrity and cell viability. The structural integrity of 300 μm liver slice under static culture was not well maintained as shown by histology, although maintenance of metabolic activities of the cells was observed. The 1-mm-thick liver slices under static culture showed the lowest metabolic activities, and the inner core of the tissues experienced severe loss of tissue integrity as shown by histology. This may be primarily due to mass transfer limitation in which only the surface of the tissue slice is involved in the nutrient uptake processes (Smith, P., et al., In Vitro Cell. Dev. Biol. (1986) 22, 706). However, in the ITP system, mass transfer limitation is overcome; hence, it allows the viability of cells residing deeper in the thick 1 mm liver slices to be maintained. The ITP-cultured liver slices consistently exhibited a significantly higher metabolic reduction activity and more intact tissue structure compared to static culture.

Liver slices cultured using ITP maintained CYP 1A activity over a 3-day culture without induction, contrary to previous studies reporting that the CYP 1A activity in 300 μm liver slices cultured in multiwell organ culture drops to undetectable levels after 2-day culture (Hashemi, E., et al., Toxicology (2000) 149, 51). Several studies have shown that the activity of many P450 enzymes in precision-cut liver slices is isoform specific and decreases during culture despite maintenance of apoproteins (Hashemi et al., 2000, supra; Renwick, A. B., et al., Drug Metab. Dispos. (2000) 28, 1202; Lake, B. G., et al., Xenobiotica (1996) 26, 197). Most of these enzymes need to be induced to increase the level of activity (Gokhale, M. S., et al., Xenobiotica (1997) 27, 341; Harrigan, J. A., et al., Toxicol. In Vitro (2006) 20, 426; Martin, H., et al., Pharm. Res. (2003) 20, 557). The ITP system demonstrated significant improvement in maintaining CYP 1A activity in thick liver slices with thickness greater than 300 μm after 3-day culture without induction.

Phase II conjugation enzymes such as UGT and sulfotransferase in liver slices are reported to be well maintained in culture at low levels (Kuhn, U. D., et al., Exp. Toxicol. Pathol. (2001) 53, 81; Hashemi, E., et al., Toxicol. In Vitro (1999) 13, 459). In the ITP system, the thick liver slices not only maintained UGT activity but also exhibited a significant increase in activity over the 3-day culture consistent with the increase in UGT activity observed in hepatocyte culture (Kataropoulou, M., et al., Tissue Eng. (2005) 11, 1263; Kern, A., et al., Biochem. Pharmacol. (1997) 54, 761). This increase may be attributed to an upregulation of UDP mRNA isoform that is responsible for the conjugation of the substrate used (Kataropoulou et al., 2005, supra; Jemnitz, K., et al., Biochem. Biophys. Res. Commun. (2002) 291, 29). For urea synthesis and albumin secretion, we have observed similar improvements in the ITP system over what have been achieved so far in static or dynamic cultures (Olinga, P., et al., Liver Int. (2005) 25, 109; Kim, J. H., et al., Yonsei Med. J. (1971) J. 12, 13; Muller, D., et al., Exp. Toxicol. Pathol. (1998) 50, 507).

The ITP system can be integrated into any scaffold for engineering large tissue constructs, by improving mass transfer to sustain long-term cell viability and functions in the inner core of the scaffold. The system can be further improved by using porous needles for in-plane delivery instead of out-of-plane delivery. In-plane delivery has the advantage of preventing needle clogging and also increases the points of fluid entry.

### Example 5

### Perfusion Using a Porous Micron-Sized Needle

This example illustrates the design of the porous needles to be integrated into the intra-tissue perfusion system described above (FIG. 13) and to interface with a selected scaffold. The scaffold selected in these examples is the poly-capro-ε-lactone (PCL) (Osteopore International, Singapore). The ITP perfusion bioreactor described in example 4 was used (supra).

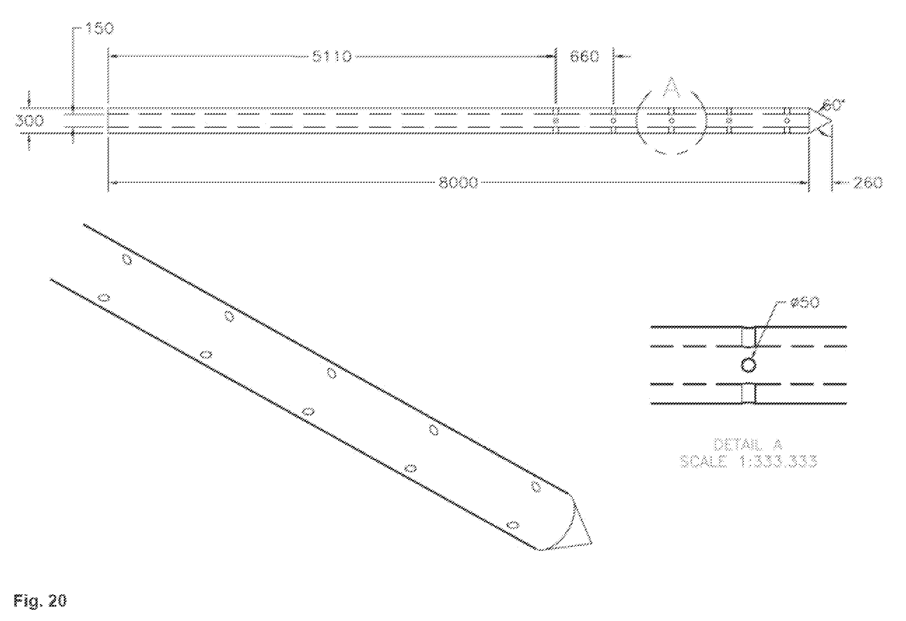

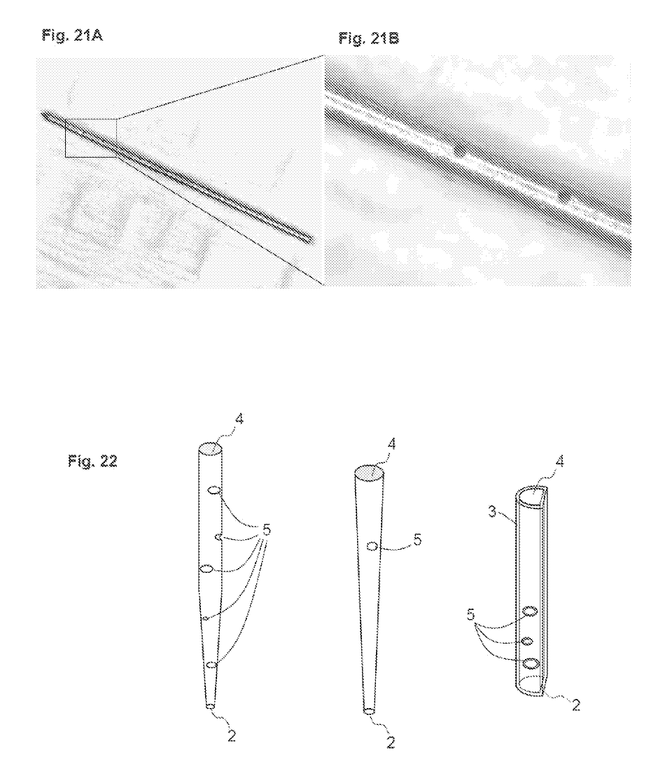

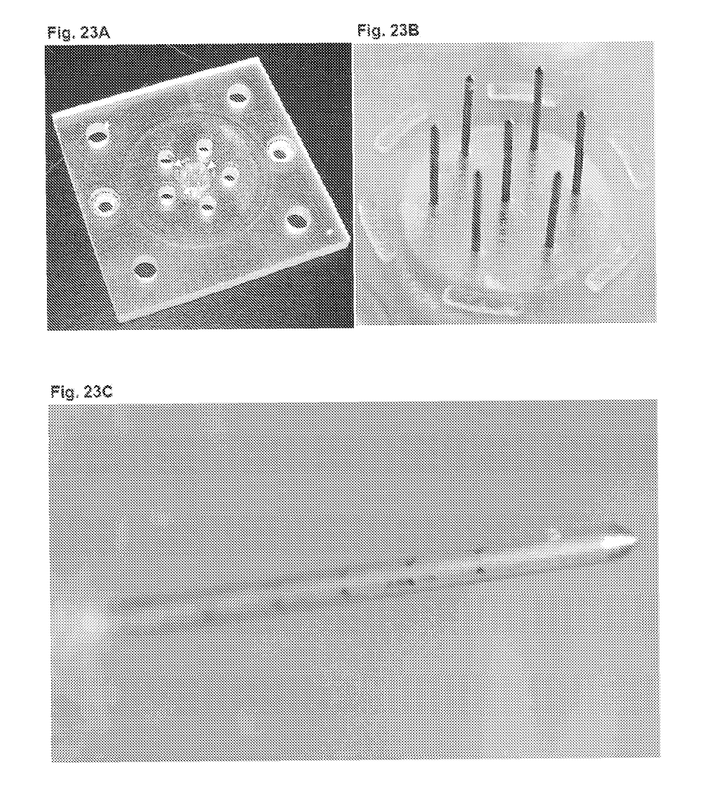

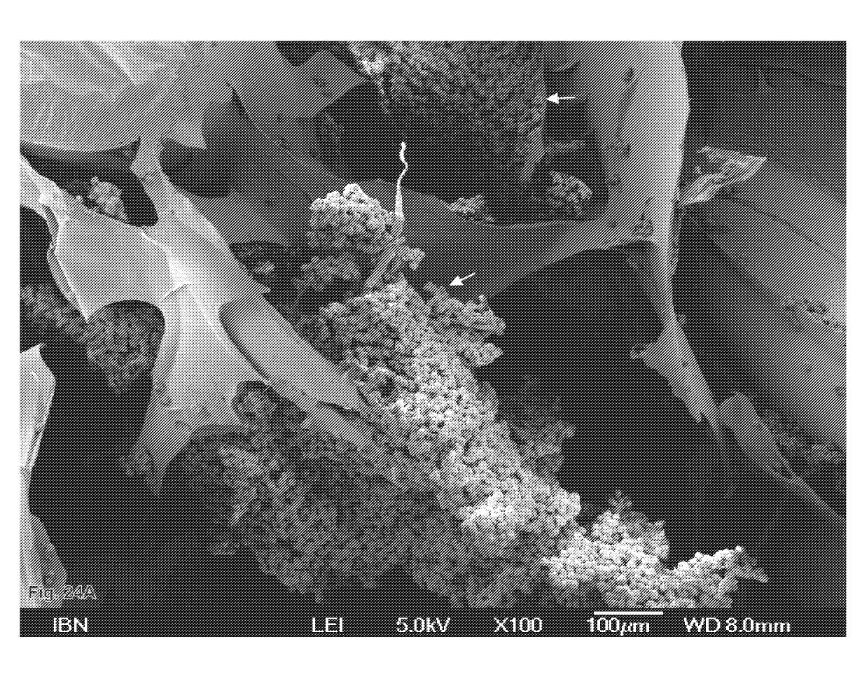

The mechanical design of the porous needles is shown in FIG. 20. The needles were fabricated via laser drilling (Vita Needle Company, Inc., Needham, Mass.) as shown in FIG. 21. The needles were designed to have an internal diameter of 150 μm and an outer diameter of 300 μm. The length of the needles as depicted in FIG. 20 is 8 mm, however, this length can be changed to adapt to varying sizes of the scaffolds. On the surface of the needles, small pores of a size of 50 μm are drilled on four sides of the needles for in-plane delivery of fluids. The distance of the small pores in the example is 660 μm to interface with the selected scaffold, which has a fiber diameter of 220 μm. The porous needles are integrated on the needle platform as illustrated in FIG. 23.

### Utilization of Intra-Tissue Perfusion System for the Culture of Hepatocytes and Stem Cells in Poly-capro-ε-lactone (PCL) Scaffolds

Maintaining adequate mass transfer in an engineered tissue construct is critical. The molecular diffusion of nutrients and oxygen is no more than a 100-200 μm from a supplying capillary. Angiogenesis and revascularization can facilitate in situ formation of blood vessel networks in tissue constructs to improve nutrients delivery and distribution. Spatial control of angiogenesis process is difficult and full revascularization takes months to complete. Dynamic culture using various engineered bioreactors can be alternatives to enhancing mass transfer and reinstating the in vivo physiological fluidics in vitro. In these systems, fluid is driven from the surface layers into the inner core of tissue constructs via convective transport or a pressure gradient. The construct surface experiences greater unremitting flow and shear than the inner core, creating a gradient in the hemodynamic environment across the construct, which is typically not experienced by cells in vivo.

Thus, a consistent delivery of nutrients via a continuous perfusion circuit through the interconnected pores of the scaffold is important to ensure cell survival throughout the entire tissue engineered construct for optimal structural and functional maintenance. For some tissues, such as liver, that naturally depend on microcirculation in vivo, the engineered internal flow in tissue constructs can reinstate more controllable hemodynamics to mimic the physiological cellular responses to their surrounding microenvironment (Ingber, D. E., Proc. Natl. Acad. Sci. U.S.A. (2005) 102, 11571-11572; Bilodeau, K., & Mantovani, D., Tissue Eng. (2006) 12, 1) Consequently, many recent tissue engineering research efforts have focused on reconstructing microcirculation structures within scaffolds to facilitate uniform nutrients delivery into the entire scaffold (Laschke, M. W., et al., Tissue Eng. (2006) 12, 1, Sachlos, E., et al., Tissue Eng. (2006) 2, 1) Reconstruction of such scaffold constructs in a consistent and reproducible manner has been less than complicated and challenging.

Instead of reconstructing microcirculation into scaffolds, the present inventors adapted their novel ITP system using an array of micron-sized porous needles to deliver nutrients into large tissue engineering construct, which comprise of a collagen cross linked poly-ε-caprolactone (PCLcollagen) scaffold seeded with primary rat hepatocytes. The needles are designed to be long with micro holes laser drilled along the needles to accommodate for the thickness of the scaffold. By adjusting the densities and the length of micro-needles, the method of the invention allows culturing tissue slices, and engineered tissue constructs of much larger dimensions (thicker and bigger) than currently possible. Instead of an out-of-plane delivery, these porous needles deliver nutrients in plane with the scaffold. The ITP utilized as intra-scaffold perfusion system provides temporary nutrient supply conduits prior to de novo re-vascularization in reconstruction of large tissue-engineered constructs. Such a scheme eases the complexity of the scaffold required for thick tissue culture and provides the versatility of independently controlling the flow rate and pressure of the system. Stainless steel porous micron-sized needles can potentially be replaced with biodegradable polymers (supra). Utilization of a porous biodegradable material can enable the cells of the tissue to grow into and occupy the porous structure, hence, creating cellular conduits mimicry of in vivo vasculature. This approach may potentially be used as a bridge to facilitate host-scaffold interactions for implantation.

### Materials and Methods

### Source of Hepatocytes and Stem Cells

Hepatocytes were harvested using a 2-step in situ collagenase perfusion as previously described (Seglen, P. O., Methods Cell Biol. (1976) 13, 29). Male Wistar rats (weight of approximately 250-300 g) were obtained from the National University of Singapore Animal Holding Unit and were anaesthetized using pentobarbitone sodium (0.1 mL/100 g, Nembutal®, Abbott Laboratories, Parramatta, NSW, Australia) and injected with 0.5 mL heparin (Leo Pharmaceuticals, Ballerup, Denmark). Livers were perfused at 37° C. with 500 mL of oxygenated Ca²⁺-free buffer followed by re-circulating 0.05% Type II collagenase (GIBCO Laboratories, Chargrin Falls, Ohio) for another 10 min. The cells were liberated from the connective tissue and resuspended in Dubelco's Modified Eagles Medium (DMEM). The cells suspension was incubated at 37° C. in a CO₂ incubator for 30 min for recovery of the injured hepatocytes, and subsequently filtered through a nylon mesh with 60 μm pore size. The filtrate was centrifuged at 50×g for 1 min at 4° C. to pellet the cells. The pellet was subsequently washed twice and centrifuged at 20×g for 1 min in DMEM. The viability of the hepatocytes was determined to be 85% or above using conventional Trypan Blue exclusion test (Seglen, 1976, supra). Human mesenchymal stem cells (hMSC) were purchased from Cambrex, Walkersville, Md.

### Perfusion Chamber Design and Perfusion System Set-Up

ITP perfusion design and set-up is as described above. A multi-channel peristaltic pump (IPC N 12, Ismatec, Glattbrugg, Switzerland) drives the fluid flow. The system was connected via Tygon® dual stop pump tubings (1.02 mm ID, Glattbrugg, Switzerland) and Silastic® laboratory tubings (1.02 mm ID, Dow Corning Corporation, MI, USA). The peristaltic pump drew fluid from a reservoir and pumped the fluid into the tissue constructs via the micron-sized needles immobilized in the needle platform. Fluid was collected in the bottom chamber and re-circulated back to the reservoir. The flow rate was controlled via a digital controller on the pump.

### ITP Culture Using Porous Needles

PCL collagen scaffolds were seeded with 0.3 mL of hepatocytes suspension at a density of 6×10⁶ cells/mL of culture medium or 0.2 mL of hMSC suspension at a density of 1×10⁶ cells/mL of culture medium via injection with a 25G hypodermic needle. The cell-seeded scaffolds were incubated in a CO₂ incubator to allow the hepatocytes or hMSC to attach to the scaffolds. After 1 hour incubation, culture medium was added to the hepatocytes seeded scaffold and further incubated for another 3 hours. Culture medium was added to the hMSCseeded scaffolds after 4 hr incubation. Cells that did not attach to the scaffolds were collected and counted to determine the seeding efficiency. The scaffolds were then placed onto the porous needles and cultured in 14 mL of culture medium. The flow rate was increased from 0.1 mL/min to 0.5 mL/min at an increment of 0.1 mL/min every 2 minutes to reduce damage associated to a sudden pressure change to the cells. The culture media used for hepatocytes culture was Hepatozyme Serum Free Medium (SFM, GIBCO Laboratories, Chagrin Falls, Ohio, USA) supplemented with 100 U/mL penicillin, 100 μg/mL streptomycin and 0.1 μM dexamethasone; whereas the culture media used for hMSC culture was MSCBM (Cambrex, Walkersville, Md.). Cell-seeded constructs cultured under static conditions were used as controls. All cultures were incubated at 37° C. and 95% O₂, 5% CO₂.

### Scanning Electron Microscope

The morphology of the scaffolds and hepatocytes in the scaffolds was characterized by scanning electron microscopy. Samples were fixed with glutaraldehyde (3% in PBS) for 30 min. The samples were dehydrated in sequential concentrations of alcohol (70%, 90% and 100%) and post fixed with an aqueous solution of osmium tetraoxide (OsO₄) (1%) at 4° C. for 30 min. Then, samples were freeze-dried overnight and cut with a razor blade and gold-coated with an ion sputter coater (JFC-1200, Jeol, Japan) at 15 MA for 80 s. Photomicrographs were acquired by scanning electron microscope (JSM-7400M, Jeol, Japan).

### Urea Synthetic Function Assay

Cells-seeded scaffolds were incubated under static condition and perfused using ITP for 1.5 h with 1 mM ammonium chloride (NH₄Cl) solution at 37° C. and 95% air, 5% CO₂. The medium was collected and conversion of NH₄Cl to urea was determined via calorimetric detection as recommended by the manufacturer (Urea Nitrogen Direct Diacetyl-monoxime Detection Kit, Stanbio Laboratory, Boerne, Tex.).

### Albumin Synthetic Function Assay

Culture medium for static and ITP culture was collected after 1-day and 3-day culture. The albumin concentration was determined using enzyme-linked immunosorbent assay (ELISA) as recommended by the manufacturer (Rat Albumin ELISA Quantification Kit, Bethyl Laboratories, Inc., Montgomery, Tex.).

### AlamarBlue Assay

AlamarBlue assay was conducted to obtain a quantitative evaluation of the cell viability. Cells-seeded scaffolds were incubated under static condition and perfused using ITP for 2 h at 37° C. and 95% air, 5% CO₂ with 10% AlamarBlue (Biosource, Camarillo, Calif.). The medium was collected and fluorescence was measured at an excitation and emission wavelength of 560 nm and 590 nm, respectively

### Statistical Analysis

Data and results are presented as the mean value±standard deviation. A student's t test was used to evaluate the significant differences between different data sets. A p-value of less than 0.05 is considered as significant.

### Results

### Hepatocyte Morphology in Scaffolds

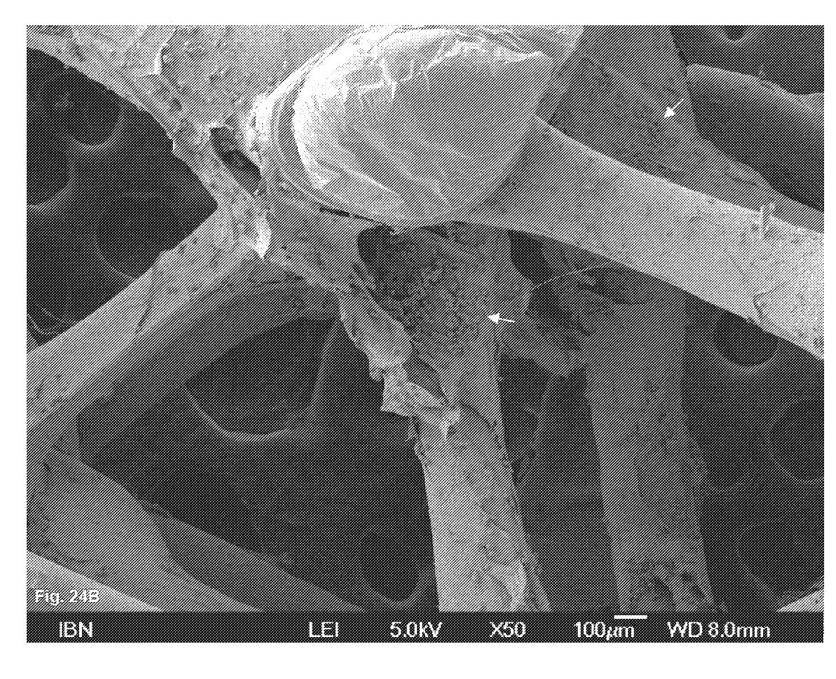

PCL-collagen scaffold seeded with hepatocytes were cultured for 24 hr and removed for scanning electron microscopy analysis to investigate cell attachment and survival (FIG. 24). The cells are efficiently seeded and trapped within the scaffold at a seeding efficiency of 89.92±2.8%. Tissue constructs cultured under ITP exhibited great masses of cell aggregates (FIG. 24A). This shows that the scaffold is suitable for cell attachment, furthermore the ITP perfusion did not wash out the cells. The high mass of cells also indicates higher cell survival and viability within the scaffolds because dead cells will detach from the scaffolds. Under static conditions, the cells mass in the scaffolds were significantly lower (FIG. 24B). The cells may have died due to lack of mass transfer and subsequently detached from the surfaces of the scaffold. Hepatocytes cultured in both systems maintained rounded morphology.

### Urea and Albumin Synthetic Functions in Hepatocytes Seeded Scaffolds

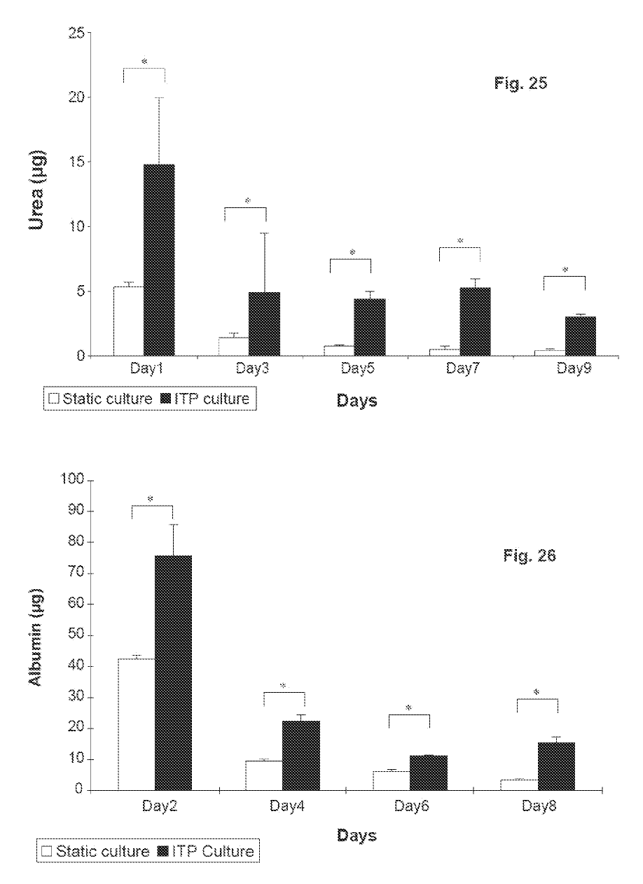

We investigated the urea synthetic functions of the hepatocytes-seeded tissue constructs in the ITP system and static condition over a period of 9 days culture to determine if the tissue constructs retained liver-specific functions. Throughout the 9-day culture, the tissue constructs cultured under ITP culture maintained significantly higher urea synthetic functions (about 3 folds higher) than tissue constructs cultured under static conditions (FIG. 25). Under static culture, urea synthetic functions are high after 1 day of culture and dropped significantly on day 3. Subsequent days of culture showed a slow decreased in functions until day 9. Under ITP perfusion culture, a significant drop in urea synthetic functions was also observed from day 1 to day 3, however, the urea synthetic function was maintained from day 3 until day 7. After 9 days of culture, the urea synthetic function dropped to almost half the level of day 7 (p<0.05).

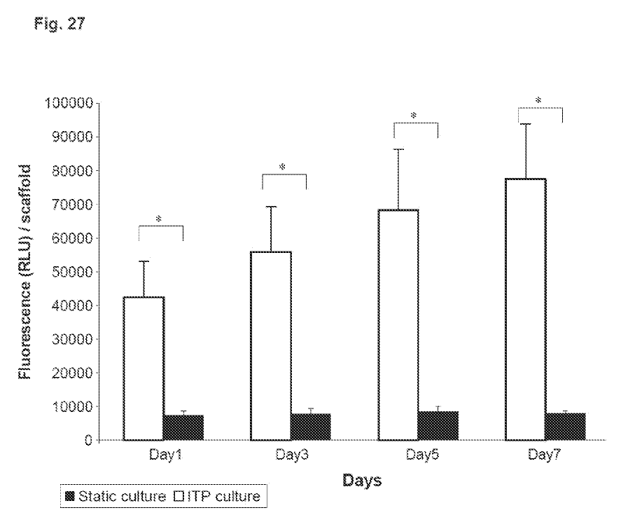

A similar trend is observed for the albumin synthetic functions (FIG. 26). Throughout the 8 days of culture, albumin synthetic activity in the scaffolds cultured in the ITP system is significantly higher than the scaffolds cultured under static conditions (about 2 folds higher) (p<0.05). There is a significant drop in albumin synthetic functions from day 2 to day 4, followed by a gradual drop in functions for both ITP and static culture. Albumin synthetic functions in the scaffold cultured under static conditions dropped at a much faster rate than the scaffolds cultured using ITP.

### Urea and Albumin Synthetic Functions in Hepatocytes Seeded Scaffolds

hMSC were seeded into PCL-collagen scaffolds for 4 hours and the seeding efficiency was determined to be 89.92±4.5% by counting the cells that detached from the scaffolds. The viability of hMSC inside the scaffolds under static and ITP perfusion culture was determined over 7 days of culture (FIG. 27). After 24 hours of culture, the ITP system demonstrated a significantly higher metabolic activity compared to static culture. The viability of hMSC under ITP culture gradually increased throughout the 7 days of culture. hMSC cultured under ITP maintained an at least 4 times higher viability compared to hMSC cultured under static conditions (p<0.05). This clearly illustrates that ITP culture supports the proliferate capabilities of hMSC much better than static conditions. Under static culture, the hMSC seeded in the inner regions of the scaffolds may have suffered mass transfer limitations, thus, restricting survival and proliferation.

### Discussion

Flow perfusion culture of large tissue constructs for tissue engineering applications is a commonly used technique to overcome mass transfer limitations. It is essential to reduce peripheral flow around the scaffold and to ensure that flow goes through the scaffold. This is critical for the entire scaffold to experience uniform delivery of nutrients, removal of waste and flow-induced mechanotransduction signaling. Most work has focused on bioreactor design to ensure good sealing between the scaffold and the reactor to minimize peripheral flow (Bancroft, G. N., et al., Tissue Eng. (2003) 9, 549,). More recent publications have focused on developing scaffolds with internal microcirculatory structures to facilitate flow through the scaffold (Sachlos, E., et al., Tissue Eng. (2006) 12, 1; Radisic, M., et al., Tissue Eng. (2006) 12, 2077). Instead of focusing on sealing and scaffolds fabrication, we utilize needles as delivery conduits to interface with the internal inter-connected pores of the scaffolds. This enables the scaffold to maintain smaller microcirculation with substantially low resistance for fluid to penetrate the surface due to the array of needles. This concept is analogous to sealing the scaffold to the reactor; however, in this approach, we are actually sealing each needle directly into the scaffold to facilitate internal flow.

In this work, we demonstrated the feasibility of using the ITP system to overcome mass transfer limitations in a large PCL-collagen scaffold seeded with hepatocytes and hMSC. Both hepatocytes and hMSC are anchorage-dependent cells and require a high surface area for attachment. After being seeded into the scaffolds, hepatocytes attached strongly, maintained rounded morphology and did not spread out onto the scaffolds inner surfaces. Such morphology is an indication of preserved differentiation and maintenance of liver-specific functions. The urea and albumin synthetic functions of hepatocytes are also significantly higher due to the higher maintenance of cell viability in the ITP cultured scaffolds. Under ITP culture using hMSC, more cells are being kept alive in the large tissue constructs compared to static conditions. This suggests that ITP improves mass transfer into the inner core of the tissue constructs, thus preventing cells from asphyxia.

The current work shows feasibility in the application of ITP using porous needles to culture a large tissue construct. Further investigations are necessary to validate its full potential as a means to overcome mass transfer limitations in engineering large tissue constructs for replacement of diseased organs. This system is particularly useful to culture shear responsive cells such as mesenchymal stem cells, endothelial cells and osteoblasts due to the direct applications of shear via the internal microcirculation of the scaffolds.

With more advanced development of polymer and microneedle technology (McAllister, D. V., et al., Ann. Rev. Biomed. Eng. (2000) 2, 289; Prausnitz, M. R., et al., Nat. Rev. Drug Delivery (2004) 2, 115), it is also possible to substitute the needles with biodegradable materials (Matsuda, T., & Mizutani, M., J. Biomed. Mater. Res. (2003) 62, 395; Park, J. H., et al., J. Controlled Release (2005) 104, 51). The biodegradable microneedle conduits can be dynamically seeded with endothelial cells, hence, facilitating revascularization within the scaffold. Incorporation of biodegradable materials into the ITP system will also enable it to be used as a temporary external microcirculatory system to facilitate integration of tissue construct into a living host.

The discussion of the references herein is intended merely to summarize the assertions made by their authors and no admission is made that any reference constitutes prior art, has any relevance to the patentability of the invention disclosed herein or refers to common general knowledge. Applicants reserve the right to challenge the accuracy and pertinence of the cited references.

The terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by exemplary embodiments and optional features, modification and variation of the inventions embodied therein herein disclosed may be resorted to by those skilled in the art, and that such modifications and variations are considered to be within the scope of this invention.

The invention illustratively described herein may suitably be practiced in the absence of any element or elements, limitation or limitations, not specifically disclosed herein. The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. In addition, where features or aspects of the invention are described in terms of Markush groups, those skilled in the art will recognize that the invention is also thereby described in terms of any individual member or subgroup of members of the Markush group.

What is claimed is:

1. A tissue system comprising:
a chamber for containing the tissue;
an outlet port fluidly coupled to the chamber;
an inlet port fluidly coupled to the chamber; and
a micro-needle, the micro-needle comprising (i) a lateral first aperture and (ii) a tip end with a second aperture,
wherein the micro-needle is arranged in the tissue system with the tip end of the micro-needle being positioned about the inlet port, and
wherein the first and the second aperture are configured for injecting a fluid into a portion of the tissue.

2. The tissue system of claim 1, wherein the micro-needle is removably arranged in the tissue system.

3. The tissue system of claim 1, further comprising a control means to maintain and/or adjust a continuous flow of the fluid through the tissue.

4. The tissue system of claim 1, wherein the inlet port and the outlet port are fluidly coupled to a recirculating system configured for providing a recirculating flow.

5. The tissue system of claim 1, wherein the micro-needle comprises a material selected from the group consisting of a metal, a metalloid, ceramics, a metal oxide, a metalloid oxide, oxide ceramics, carbon and a polymer.

6. The tissue system of claim 4, wherein the polymer is a biodegradable polymer.

7. The tissue system of claim 1, wherein the needle has an inner width from about 10 microns to about 1000 microns.

8. The tissue system of claim 1, wherein the first aperture is an opening with a width from about 5 microns to about 100 microns.

9. The tissue system of claim 1, comprising a plurality of micro-needles.

10. The tissue system of claim 1, wherein the micro-needles are fluidly coupled.

11. The tissue system of claim 9, wherein the micro-needles of the plurality of micro-needles are arranged at a distance from each other.

12. The tissue system of claim 11, wherein the distance is selected in the range from about 0.2 to about 10 mm.

13. The tissue system of claim 11, wherein the micro-needles of the plurality of micro-needles are arranged at an at least essentially equal distance to each other, thereby defining an at least essentially regular polygon.

14. The tissue system of claim 1, wherein the tissue is obtained from an organism or is an engineered tissue construct.

15. A method of perfusing a tissue contained by a chamber of a tissue system,
wherein the tissue system further comprises an outlet port fluidly coupled to the chamber, an inlet port fluidly coupled to the chamber, and a micro-needle,
wherein the micro-needle comprises (i) a lateral first aperture and (ii) a tip end with a second aperture and wherein the micro-needle is arranged in the tissue system with the tip end of the micro-needle being positioned about the inlet port,
the method comprising injecting through the micro-needle a fluid into a portion of the tissue.

16. The method of claim 15, wherein the micro-needle is removably arranged in the tissue system.

17. The method of claim 16, further comprising arranging the micro-needle in the tissue system.

18. The method of claim 15, wherein the micro-needle is inserted into the tissue to an extent that fluid can be perfused via both the first and the second aperture.

19. The method of claim 15, further comprising flowing the fluid continuously through the tissue.

20. The method of claim 15, further comprising recirculating the fluid.

21. The method of claim 15, wherein the fluid is injected through a plurality of micro-needles.

22. The method of claim 21, wherein the plurality of micro-needles is fluidly coupled.

23. The method of claim 21, wherein the plurality of micro-needles are arranged at a distance from each other.

24. The method of claim 21, wherein the micro-needles of the plurality of micro-needles are arranged at an at least essentially equal distance to each other, thereby defining an at least essentially regular polygon.

25. The method of claim 15, wherein the tissue is obtained from an organism or is an engineered tissue construct.
